(19) United States
(12) Patent Application Publication
(10) Pub. No.: US 2017/0301015 A1
(43) Pub. Date: Oct. 19, 2017

(54) Method and System to Automatically Trade Financial Tradeable Assets and Manage Financial Accounts

(71) Applicant: Andrew Tunnell, Palm Bay, FL (US)

(72) Inventor: Andrew Tunnell, Palm Bay, FL (US)

(21) Appl. No.: 15/455,084

(22) Filed: Mar. 9, 2017

Related U.S. Application Data
(60) Provisional application No. 62/305,650, filed on Mar. 9, 2016.

(51) Int. Cl. G06Q 40/04; G06N 99/00; G06N 7/00

(52) U.S. Cl. CPC G06Q 40/04; G06N 7/005; G06N 99/005

(57) ABSTRACT

The present invention consists of a trading system and methods of such that allow a user to easily build trading systems and trading strategies within the trading system, that automatically trade financial tradeable assets across financial markets. Through a graphical user interface (GUI), the user is given control to build, modify, replace, and/or execute trading strategies and trading systems. Within the present invention, methods are also disclosed wherein an AI (artificial intelligence system) performs these actions.

### CROSS REFERENCE TO RELATED APPLICATIONS

This patent application claims the benefit of U.S. provisional patent application filed on Mar. 9, 2016 and assigned Application No. 62/305650, which is incorporated herein in its entirety.

### FIELD OF THE INVENTION

The present invention relates to the general fields of algorithmic and quantitative trading and AI (artificial intelligence) systems management.

### BACKGROUND OF THE INVENTION

Personal financial management is often a troublesome task. Investing and its due diligence, is usually left to a professional, such as a broker or a financial advisor. In fact, this is what is often done when it comes to one's personal finances. However, the delegation of such important responsibilities can often be detrimental to the investor's financial account, as these various trustees often make mistakes, which often costs the investor money.

When investors don't delegate the task, they usually take matters into their own hands by trading the market themselves. Technical and fundamental analyses are both often used by the investor to maximize profits and reduce risk. However, the mastering of these skills is often extremely difficult and time consuming, making it nearly impossible for investors with different career paths to advance themselves financially through the market. Even with the required skills for making a profitable trade, human error still comes into play.

As a result of these problems, many people do not try to better themselves financially through the trading of financial tradeable assets because they have often experienced substantial losses, causing them to completely give up on the practice. Today the number of people who do trade outnumbers the people who do not. For the numerous people that don't trade, many financial opportunities are missed, keeping them at a financial disadvantage.

While little has been done to address this problem, several algorithmic trading platforms do exist. In U.S. Application 20110093378A1, a drag and drop platform is described. Therein, a user can define a trading algorithm by dragging and dropping different operators. A few other drag and drop platforms, such as Prodigio's Wizard Lab, have also been developed.

While these platforms do let the user trade algorithmically, they are often too complicated for the user to use, and require the user to know computer logic and technical analysis terminology, alienating most of the population. The aim of the present invention is to solve these problems, making algorithmic trading easy to understand and simple to execute. The present invention also introduces many new and unique methods to make the process of algorithmic and quantitative trading more accurate and profitable.

### SUMMARY OF THE INVENTION

The present invention discloses systems and methods that allow a user to build an automated trading strategy and/or an automated trading system using a simplistic graphical user interface (GUI). Within some of the methods and systems of the present invention, an AI system controls, modifies and builds the automated trading strategy and/or the trading system.

### BRIEF DESCRIPTION OF THE DRAWINGS

FIG. 1 is an example of a home page display where each sub-trading strategy is part of the cumulative trading strategy.

FIG. 2 is an example of a selection page display containing sub-trading strategies stored in memory.

FIG. 3 is an example of a settings page display containing strategy limits to control how the sub-trading strategy trades.

FIG. 4 is an example of how a recommendation may be displayed to the user.

FIG. 5 illustrates how a recommendation may be tested and its performance metrics received.

FIG. 6 illustrates how a recommendation may be found through data mining.

FIG. 7 is an example of how potential trades and execution time may be displayed to a user.

FIG. 8 is an example of a display to a user to alert the user when they select an incompatible GUI trading system parameter.

FIG. 9 illustrates how different GUI trading system parameters may be controlled through the graphical user interface.

FIG. 10 is an example of how the amount of capital allocated can be adjusted through the graphical user interface.

FIG. 11 is an example of how holding time may be adjusted through the graphical user interface.

FIG. 12 is an example of how times of operation for each trading strategy may be adjusted through a graphical user interface.

FIG. 13 is an example of how a graphical user interface may be used to adjust, “when” a hedge position is taken, “size” a hedge position is taken, and the “type” of hedge position taken.

FIG. 14 illustrates how an AI system or a logic engine of the trading system can adjust, build, and test, trading system components.

### DETAILED DESCRIPTION OF THE INVENTION

Before describing in detail the particular methods and apparatuses related to the different methods of allowing the management and viewing of the operation of an autonomous trading system, it should be observed that the embodiments of the present invention reside primarily in a novel and non-obvious combination of elements and method steps. So as not to obscure the disclosure with details that will be readily apparent to those skilled in the art, certain conventional elements and steps have been presented with lesser detail, while the drawings and the specification describe in greater detail other elements and steps pertinent to understanding the embodiments. The presented embodiments are not intended to define limits as to the structures, elements or methods of the inventions, but only to provide exemplary constructions. The following embodiments are permissive rather than mandatory and illustrative rather than exhaustive.

The present invention consists of several non-obvious and unique methods and systems to build, control, and view the different components and functions of an automated trading strategy. Under the present invention, a “logic engine(s)” is defined as any logical component that performs one or more operations of one or more trading systems, trading strategies or the components of such. Under the present invention, an automated trading strategy is defined as one or more logic engines that use or perform one or more technical analysis, fundamental analysis, event-based, numerical, or statistical studies, observations, and/or calculations of or on tradeable financial assets, markets, or market conditions or phenomenon to in part or in whole, automatically and electronically find, execute, manage, and exit trades of one or more tradeable financial assets. The automated trading strategy, also referred to as “trading strategy” or “trading strategies” can be used to trade one or more asset classes or a combination of asset classes including but not limited to stocks, bonds, futures, options, derivatives, or any other asset class known to those versed in the art.

In preferred embodiments of the present invention the process of finding, executing, managing and exiting trades, herein referred to as the “trading process”, is fully automated, while establishing and controlling the trading strategy and its parameters are left for the user to control and define through a simple graphical user interface (GUI), hereafter referred to as the “GUI” or the “GUI platform.”

However, in other embodiments the trading process could be fully manual or one or more combinations of automated and manual trading processes. In embodiments where the trading process is fully manual or semi-manual, the one or more trading strategies may indicate to the user, based on technical analysis, fundamental analysis, event-based, numerical, or statistical studies, observations, and/or calculations, one or more tradeable financial assets that may be traded. In such embodiments, the user would have the option to place a trade on one or more of the indicated tradeable financial assets, through the GUI.

The graphics of the GUI that a user may use to build, control, and view the different components and functions of an automated trading strategy will hereafter collectively be referred to as “trading system graphic(s).” Trading system graphics may include but are not limited to graphical switches, drag options, levers, or buttons, text, text boxes, and the like. Trading system graphics may also include but are not limited to drop-downs, icons, logos, or any other graphics and the like. Operations as defined in the present invention may include but are not limited to “selecting,” “dragging,” “clicking,” “pressing (as with a finger),” or any other operation on a trading system graphic and the like.

Under preferred embodiments of the present invention, a trading strategy built from the selecting and weighting of two or more trading strategies will herein be referred to as a “cumulative trading strategy,” and each trading strategy selected and weighted to form the cumulative trading strategy will hereafter be referred to as “sub-trading strategies.” In preferred embodiments, cumulative trading strategies are made up of multiple strategies.

In many embodiments, the cumulative trading strategy is assisted by one or more logic engines that affect the trading process, including but not limited to one or more execution engines, risk management engines, order management engines, loss management engines, or any other logic engines that may assist a cumulative trading strategy known to those versed in the art. These logic engines will hereafter be referred to as the “backend” or as “logic engine(s) of the backend.” Under preferred embodiments of the present invention, each trading strategy is used in correlation with the backend to execute the trading process.

In many embodiments, the user may perform one or more operations on one or more trading system graphics to view, define, and/or control parameters, limits, sensitivities, settings, or functions of, or related to the one or more cumulative trading strategies, sub-trading strategies, the backend, and/or the trading account. These parameters, limits, sensitivities, and settings of the trading system will hereafter be referred to as “GUI trading system parameter(s).” GUI trading system parameters may include but are not limited to capital allocation, margin allocation for short and long positions, total margin allocation, short versus long position allocation, capital allocated per position, holding time per position, the types of stocks traded, the types of hedged positions, the percent to hedge against a position, the types of orders used for short and long positions, bullish or bearish sentiment, time periods, candlestick time periods, moving average types, moving average periods, adjustable models, weights, or any other parameter, limit, or setting of or related to the present invention.

In several embodiments, the GUI is connected to and is used to build, view, control, manage, define and/or execute the one or more cumulative trading strategies, sub-trading strategies, the GUI trading system parameters and the correlating logic engines of backend and/or their aspects or various components. The totality of these one or more correlated components: cumulative trading strategies, sub-trading strategies, logic engines of the backend, and the GUI trading system parameters will hereafter cumulatively be referred to as the “trading system” or the “automated trading system.” Under the present invention, a trading system is defined to be comprised of at least one trading strategy. Each of the components of the trading system may also be referred to individually as a “trading system component(s)” hereafter. Those versed in the art will also recognize that the trading system is managed and controlled by the user through the GUI and that the GUI may be considered as part of the trading system even though it may not have logical components. In most embodiments, each of these components are correlated in operation to effectively execute the trading process. If any elements associated with a trading system are revised as described herein, then the trading system may be referred to as a “revised trading system.”

In some embodiments, when a user performs one or more operations on one or more trading system graphics, the user is changing the trading strategy, the trading system which includes the trading strategy or one or more trading system components fundamentally, mathematically, and/or technically. As a non-limiting example, when a user changes an algorithmic model, he or she is making a new algorithmic model.

Under the present invention, when an automated trading strategy or a trading system including at least one trading strategy is operating across one or more markets, it is executing the trading process. When the trading system, the automated trading strategy, or one or more logic engines of the backend execute trades, orders are sent out to entities including but not limited to the following: a market maker, a financial institution, a hedge fund, an exchange, ETF an electronically traded fund, a mutual fund, a credit union, an investment bank, a full-service broker, a discount or online broker, a private trader, or any other entity that receives and places trades known to those versed in the art.

### Network Set Up

The overall system and its various non-limiting methods of the present invention may be executed over one or more processing architectures herein described. However, such architectures are for purposes of example only and are non-limiting.

One or more cumulative trading strategies, sub-trading strategies, logic engines of the backend, GUI trading system parameters, data archives, API's (application program interfaces) and data feeds are essential to the operation and will herein be referred to as “software components.”

One or more servers, computers, computing devices, clouds, mobile devices or any other device that may house one or more software components will herein be referred to as a “network” or “network device(s).”

User platforms as referred to herein may include but are not limited to mobile devices, tablets, personal computers, smart phones, smart watches, smart wallets, smart cards and the like. User platforms may also include but are not limited to a browser or application on one or more devices. User platform(s) may be referred to as “user device(s),” herein.

In some embodiments, one or more software components may be stored on the network. However, in other embodiments, one or more software components may be stored on the user platform. In yet other embodiments, one or more software components may be stored on the user platform, while one or more other software components may be stored on the network. In preferred embodiments of the present invention, software components are stored and run from network devices, such as remote servers, while the GUI is local to (stored on) one or more user platforms including but not limited to a mobile device, or any other user device known to those versed in the art. In such embodiments, the GUI trading system parameters may be stored on both the network devices and the user platform. Those versed in the art will readily recognize that by storing and running most of the software components on servers, the process and various methods of the present invention will be executed faster without consuming processing speed, memory, and power of the user platform. Herein, by selecting and weighting one or more trading strategies and/or setting one or more GUI trading system parameters, the user is simply indicating changes that need to be made to one or more components of the trading system or the user's trading account and saved on one or more network devices or user platforms. Under such embodiments, the trading strategy and the backend may run on the one or more clouds or servers, while the user simply controls the settings of the trading strategy from the simplistic GUI.

Those versed in the art will readily recognize that a secure connection may be made between the user device and the network devices, as well as between each software component. Under the present invention, one or more, non-limiting methods of authentication may be used to establish one or more secure connections between the user device and the network devices as well as between each software component.

Under some embodiments (non-limiting) a user may cast or mirror the GUI and its settings from one or more devices to one or more other devices. Those versed in the art may readily recognize that an authentication between the two devices may need to be established before the casting of the GUI and its settings may be executed. In some embodiments of the present invention, the user may have the GUI and its settings stored on multiple devices.

### Trading Strategies Definition

Trading strategies as discussed herein may include but are not limited to one or more logic engines used to find, execute, manage, and/or exit trades based on technical analysis, fundamental analysis, event-based, numerical, or statistical studies, observations, and/or calculations including but not limited to the following: news reports, including financial news, company news, and social media news, volume, volume as related to a given period of time (3 month or 6 month etc.), volume as related to the float, the float, chart formations, and/or candle stick formations, free cash flow, cash flow, operating cash flow, levered free cash flow, earnings per share (EPS), diluted EPS, revenue, revenue per share, assets, liabilities, growth, quarterly revenue growth, quarterly earnings growth, long term investments, intangible assets, fixed assets, prepaid expenses, marketable securities, accounts receivables, allowance for doubtful accounts, retained earnings, debt-to-equity ratio, acid-test ratio, market capitalization, enterprise value, trailing price to earnings, forward price to earnings, price/earnings to growth ratio, price to sales ratio, price to book ratio, enterprise value to revenue, enterprise value to EBITDA (earnings before interest, taxes, depreciation, and amortization), EBITDA, EBIT (earnings before interest and taxes), profit margin, operating margin, return on equity, return on assets, net income, net income available to common, quarterly earnings growth, total cash, cash per share (common preferred etc.), current ratio, total debt to equity, total debt, book value per share, shares outstanding, percent held by insiders, percent held by institutions, number of shares short, percent shares short of float, shares short prior time period, short ratio, time period highs (52 week high/low), dividend data, ex-dividend date, split dates, dividend yield (forward annual, trailing annual, 5 year average dividend yield, payout ratio, or any other technical analysis, fundamental analysis, event-based, numerical, or statistical study, observation, and/or calculation known to those versed in the art.

In some embodiments of the present invention, a trading strategy includes but is not limited to one or more logic engines used to find, execute, manage, and/or exit trades based on one or more technical analysis, fundamental analysis, event-based, numerical, or statistical studies, observations, and/or calculations including but not limited to the following: Exponential Moving Average (EMA), Simple Moving Average (SMA), Smoothed Moving Average (SMMA), and Triangular Moving Average (TMA) Bollinger bands, MACD, Direction Movement Index (DMI), Money Flow Index (MFI), Price Channel (PC), RSI, Parabolic SAR (SAR), Stochastic Fast (SF), Stochastic Slow (SS), William Percent R (WR), Average True Range (ATR), On Balance Volume (OBV), Median Price (MED), Probability Analysis, Typical Price (TYP), Weighted Close, (WCL), Accumulation Distribution (AD), ADX, Average True Range (ATR), CCI, Chaikin Oscillator (CHO), Chaikin Volatility (CHV), Chaikin Money Flow (CMF), DI−, DI+, Detrended Price Oscillator (DPO), Directional Index (DX), Ease of Movement (EMV), Force Index (FI), Mass Index (MI), Negative Volume Index (NVI), Price Oscillator (PO), Positive Volume Index (PVI), Price and Volume Trend (PVT), Rate of Change (ROC), Volume Rate of Change (ROCV), Standard Deviation (SMD), True Range (TR), TRIX, Williams AD (WAD), Williams Percent R (WR), the bid-ask spread, the rate of change of the order book, or any other technical analysis, fundamental analysis, event-based, numerical, or statistical study, observation, and/or calculation known to those versed in the art.

Those versed in the art will recognize that technical analyses, fundamental analyses, event-based, numerical, and statistical studies such as the ones previously mentioned may be replaced, changed, or modified as the landscape of domestic and international financial markets change. Therefore, new trading strategies including but not limited to one or more logic engines used to indicate or execute, manage, and/or exit trades based on new technical and financial studies may be developed.

In some embodiments of the present invention, a trading strategy includes but is not limited to one or more logic engines used to find, execute, manage, and/or exit trades based on one or more chart formations or candlestick chart formations, wherein such formations can include but are not limited to the following: a wedge, an upward wedge, a downward wedge, a double top, a double bottom, a morning star, a head and shoulders, a triple top, a triple bottom, a bump in run, a flag formation, a symmetrical triangle, an ascending triangle, a descending triangle, a rectangle formation, a channel formation, a cup and handle, a bullish measured move, or a bearish measured move. The detailed shapes of these patterns are known to those skilled in the art. Other known chart patterns (candle stick patterns) may include Marubozu, spinning tops, doji, long white candle with doji, long black candle with doji, long legged doji, dragon fly doji, grave stone doji, star positions, harami positions, hammers, a hanging man, an inverted hammer, a shooting star, piercing formations, dark cloud cover or any other chart pattern for financial tradeable assets known to those versed in the art and the like. Each of these types of chart patterns is non-limiting, as they are used only for example, and may occur during either larger or smaller time frames.

Those versed in the art will readily recognize that patterns such as these are not always guaranteed to represent bullishness or bearishness of a given tradeable financial security due to an ever changing and developing market and may be subject to change as new market-changing forces continue to affect the market. In some non-limiting instances, new chart patterns may be discovered and one or more logic engines may be developed to find, execute, manage, and exit trades based on new chart or candlestick patterns.

### Building a Strategy Using Weights

Under one method of the present invention, the user may build a cumulative trading strategy by selecting and weighting one or more sub-trading strategies. Herein, the user can build a cumulative trading strategy by performing one or more operations on one or more trading system graphics to select and weight one or more sub-trading strategies. In most embodiments, a sub-trading strategy may be weighted by means including but not limited to selecting and/or dragging different trading system graphics.

Under preferred embodiments, each sub-trading strategy and cumulative trading strategy has an individual “settings page” within the GUI where the user can adjust one or more GUI trading system parameters of either a sub-trading strategy or a cumulative trading strategy. The settings page of any trading strategy will herein be referred to as the “settings page.” As a non-limiting example, the user may “click” or “press” on a trading system graphic representing the ascending triangle sub-trading strategy. After “clicking” or “pressing” on the trading system graphic the user will be taken to the ascending triangle sub-trading strategy's settings page.

In preferred embodiments, the user can select each sub-trading strategy from a “list” or “page” of sub-trading strategies within the GUI, hereafter referred to as a “selection page.” Each sub-trading strategy desired by the user may then be selected and weighted to build a new cumulative trading strategy.

In one embodiment, the selection page is a different page of the GUI and is accessed by a performing one or more operations including but not limited to “clicking” or “pressing” the selections page's unique trading system graphic. Under preferred embodiments, sub-trading strategies on or in the selection page are not active in the cumulative strategy and are storage. Each sub-trading strategy may be represented by a simplistic icon, logo, or “button” on the GUI. By selecting one or more sub-trading strategies from the selection page, the user is building and defining a trading strategy without the need to do any coding.

Those versed in the art may see that being able to weight different sub-trading strategies against each other in order to build a cumulative trading strategy, gives the user control of the strategy by allowing him or her to decide which technical analysis, fundamental analysis, event based, numerical, or statistical studies, observations, and/or calculations are most important for the current or future market conditions.

When a sub-trading strategy is weighted, it is weighted against the one or more other sub-trading strategies within the cumulative trading strategy, effectively valuing each sub-trading strategy within the cumulative trading strategy. In most non-limiting embodiments of the present invention, weights may be represented by numbers including but not limited to percentages. In preferred embodiments, weights of sub-trading strategies may be changed from one or more user devices using the GUI.

In some embodiments of the present invention a single sub-trading strategy may make up one cumulative trading strategy. To those versed in the art it would be obvious that this lone, sub-trading strategy may have a weight of 100%. Under some embodiments, when a user selects two or more sub-trading strategies to form a cumulative trading strategy, the weights are automatically distributed so that all sub-trading strategies within the cumulative trading strategy have the same value. As a non-limiting example, a user may select four sub-trading strategies and each may be assigned a weight of 25%. Under most embodiments, after the user has selected these sub-trading strategies and they are automatically weighted, the user can change the weight of each sub-trading strategy.

In preferred embodiments of the present invention, a user may perform one or more operations on one or more trading system graphics to change the weights of each sub-trading strategy to any numerical value. Under one non-limiting example, a user may select two sub-trading strategies and use a drag-option to weight the first sub-trading strategy with a weight of 25% and the second sub-trading strategy with a weight of 75%, effectively building a cumulative trading strategy.

As a non-limiting example, multiple sub-trading strategies may be selected and each individually weighted to form a cumulative trading strategy. The weight of each sub-trading strategy reflects each sub-trading strategy's value within the cumulative trading strategy. In some embodiments of the present invention, when the weight of one sub-trading strategy is changed the weights of the other sub-trading strategies within the cumulative trading strategy will also change automatically. Herein, the weight of each sub-trading strategy may be automatically set so that the total weights of the sub-trading strategies adds up to 100%.

### Scoring Process

In one method of the present invention a scoring process is used to assign each tradeable financial asset a score, hereafter referred to as a “cumulative score.” Each cumulative score is produced and calculated by one or more logic engines of the trading system and is representative of a current or future change in price for a specified tradeable financial asset, as indicated by one or more technical analysis, fundamental analysis, event-based, numerical, or statistical studies, observations, occurrences, and/or calculations of each sub-trading strategy. Those versed in the art will recognize that a change in price may include but is not limited to a break-out, a break-down, a steady climb in price or any other price movement of a tradeable financial asset. In some embodiments, the cumulative score could may also represent the probability of a successful trade.

Under the present invention, each cumulative score is a score made up of individual one or more scores produced from each sub-trading strategy, hereafter referred to as “sub-scores.” Each sub-score represents the scoring of one or more tradeable financial assets as produced and defined by the logic of a sub-trading strategy. Each sub-score is also representative of a changed in price for a specified tradeable financial asset, as indicated by one or more technical analysis, fundamental analysis, event-based, numerical, or statistical studies, observations, occurrences, and/or calculations of each sub-trading strategy. In some embodiments, each sub-score may represent the probability of a successful trade. In preferred embodiments, the score produced by each sub-trading strategy is weighted using the weight of each sub-trading strategy defined by the user. The weight of each sub-trading strategy is applied to each sub-score to produce the cumulative score from a weighted-average of all the sub-scores, in preferred embodiments.

Under most embodiments, the trading system will only place a trade for a tradeable financial asset if the cumulative score of the tradeable financial asset is at or above a specified threshold, hereafter referred to as the “cumulative limit.” The user can define the cumulative limits through one or more operations on one or more trading system graphics, in preferred embodiments. However, in other embodiments, one or more logic engines of the trading system may adjust the cumulative limit automatically, in response to one or more market, market sector, or industry conditions. In yet other embodiments, the cumulative limit is predefined within the trading system.

Under one embodiment of the present invention, the user may perform one or more operations on one or more trading system graphics to adjust a sub-trading strategy's one or more parameters, sensitivities, limits or specifications, hereafter referred to as “strategy limits.” Strategy limits are types of GUI trading system parameters as referred to in the present invention used to define and control each sub-trading strategy and may include mathematical and/or fundamental parameters, sensitivities, limits, or specifications. As non-limiting examples, mathematical adjustments may be the number of shares traded in the “volume” sub-trading strategy, while fundamental adjustments may be the type of news filtered in the “news” variable. Strategy limits can include but are not limited to time periods, moving average types, time periods of moving averages, adjustable model definitions, adjustable ratios, the candle stick time period on candle stick charts, and any other non-limiting parameter, limit or setting to define a sub-trading strategy as defined herein. Other strategy limits may include selecting whether a sub-trading strategy and/or cumulative trading strategy is long or short, the percent accuracy based on the model used in the trading strategy, or a limit for a ratio. For a non-limiting example, a user may select a Bollinger band expansion strategy to be short using a short/long switch and set the percent accuracy of the expansion model to 65% expansion.

In order to define a sub-trading strategy's strategy limits, a user must first perform one or more operations including but not limited to “clicking” or “pressing” (as with a finger) the trading system graphic representing the sub-trading strategy. Herein, the sub-trading strategy's settings page is opened when the user “clicks” or “presses” a sub-trading strategy. Strategy limits may be defined under each sub-trading strategy's settings page in one non-limiting embodiment of the present invention. A user may then use one or more trading system graphics to set the parameters, limits and/or sensitivities of the sub-trading strategy or other GUI trading system parameters of the present invention. Those versed in the art will readily recognize that by changing the parameters, sensitivities, or limits of the sub-trading strategy, the user is further defining and building both the sub-trading strategy as well as the cumulative trading strategy in a very short time period without any coding.

In one non-limiting example, a user may select an SMA moving average type with a 14-day moving average time period using the GUI. The user may then select a 10-day chart-time period, a 5-minute candle-time length and a weight of 75% for a given sub-trading strategy. The other sub-trading strategies within the cumulative trading strategy would then cumulatively adjust to make up 25% of the cumulative trading strategy. Thereafter, the user may execute the automated trading strategy and the automated trading strategy would follow these parameters.

### The Whole Story

With the present invention, a user can select multiple sub-trading strategies to start building a cumulative trading strategy. In some embodiments, the sub-trading strategies that the user selects may each have equal weights. After the sub-trading strategies have been selected, the user may then select each sub-trading strategy's trading system graphic from the home page to access their individual settings pages. Within each settings page, the user can then change the weight of each sub-trading strategy and any other strategy limit of each sub-trading strategy by using the trading system graphics of the GUI.

Once the user has built a cumulative trading strategy, he or she may back and/or forward test the trading strategy by performing one or more operations on one or more trading system graphics. Those versed in the art will recognize that by forward testing, a trading strategy is executed against current or simulated market data, and a trading strategy is executed against historical market data during back testing. In preferred embodiments, the location of the trading system graphic to back test, hereafter referred to as the “back testing button,” is on the home page of the trading system, and may be in the form of an icon, button, or switch. However, in other embodiments, the back-testing button is on multiple pages of the GUI.

In preferred embodiments, a user is requested to forward or back test their cumulative trading strategy before executing it with a real account. In some embodiments, a user may be denied access to executing a cumulative trading strategy if the given back and/or forward test results do not meet certain requirements or thresholds. Under some embodiments, these thresholds or requirements for back testing are defined by the user. However, in other embodiments these requirements are defined by one or more logic engines of the trading system or are predefined. As a non-limiting example, if a cumulative trading strategy's maximum draw down exceeds 15%, the trading system will not allow the user to execute the cumulative trading strategy using a real account.

In several embodiments if a cumulative trading strategy's back and/or forward test results have met certain requirements or thresholds, the user may then execute the cumulative trading strategy across one or more financial markets using a real account. In some embodiments, the user may execute the cumulative trading strategy and the one or more correlating logical software components of the trading system across one or more financial markets by pressing or clicking a button. In other embodiments, the cumulative trading strategy is executed across one or more financial markets by one or more logic engines of the trading system when the cumulative trading strategy has passed the required back or forward test.

In preferred embodiments of the present invention, there are trading system graphics for starting and stopping the execution of the cumulative trading strategy and the trading system. In most embodiments, there is also a trading system graphic for closing out all positions. All of these trading system graphics are usually on the home page of the GUI. However, in other non-limiting embodiments they may be stored on one or more other pages of the GUI as well.

Once the user has executed the cumulative trading strategy, the trading process is executed by the correlated operation of trading system components.

### Recommended Strategies Method

The present invention also consists of a method wherein the trading system, or one or more logic engines of or independent of the trading system, recommend one or more trading system components including but not limited to one or more cumulative trading strategies or sub-trading strategies to one or more users. Under preferred embodiments, cumulative trading strategies and sub-trading strategies are recommended with each of their individual and unique strategy limits. As a non-limiting example, a Bollinger band sub-trading strategy with a 10-day time frame, as one strategy limit, may be recommended to multiple users.

The trading system or one or more logic engines of or independent of the trading system may also recommend one or more GUI trading system parameters to one or more users. According to a non-limiting example, the trading system may recommend the user to hold positions over night and to use limit orders for short positions. Recommended cumulative trading strategies, sub-trading strategies, logic engines of the backend, and GUI trading system parameters, including strategy limits, will hereafter be referred to as “recommendation(s).” In preferred embodiments, a user can “select” or “choose” one or more recommendations, and the one or more recommendations will thereafter be installed in the trading system automatically. Recommendations may be displayed to the user on a “recommendations page” either online or within the GUI of the trading system, through social media, email, text message, or through a pop-up displayed within the GUI of the trading system.

Under some embodiments of the present invention, the trading system or one or more logic engines of or independent of the trading system recommends to users one or more trading system components based on each's individual or collaborative performances, while used in live or simulated financial markets by one or more users. Performance may be measured by one or more “performance metrics” as referred to under the present invention, including but not limited to one or more of the following: profitability, number of losses, average profit per trade, risk adjusted return (RAR), number of trades, profit factor, percent winning trades, compounded annual growth rate, draw-down, the best equity curve, t-test, expectancy, or by the expectancy score. Those versed in the art will recognize each of these performance metrics as industry standards to measure a trading strategy's performance. Herein, one or more recommendations may include but are not limited to cumulative trading strategies, sub-trading strategies, logic engines of the backend, or GUI trading system parameters developed, adjusted, and/or used by one or more users.

In some embodiments, the performances of one or more recommendations may be measured by their profitability as used across many user accounts and within many user trading systems. This profitability or the effect on probability may be measured by taking an average or other statistical, numerical, or mathematical study of the profitability or the effect on profitability as observed across many user trading systems. To tell how a recommendation performed within each trading system of multiple users and possibly hundreds, thousands, or millions of users; data mining may be used, as in preferred embodiments. Those versed in the art will recognize that by data mining the results of one or more cumulative trading strategies, sub-trading strategies, logic engines of the backend, or GUI trading system parameters; a numerical or statistical view of each recommendation can be formulated and developed.

In some embodiments of the present invention, the trading system or one or more logic engines of or independent of the trading system may recommend one or more trading system components or a combination of such to users based on each trading system component's performance when tested. In some embodiments, one or more logic engines of or independent of the trading system may execute one or more of these trading system components against historical, real time or simulated financial market data during back testing or forward testing. The one or more logic engines of the trading system will then record the results and recommend the cumulative trading strategies, sub-trading strategies, logic engines and/or GUI trading system parameters that had the best results. Herein, results could include but are not limited to maximum drawdown or profit.

In some embodiments, the trading system or one or more logic engines of or independent of the trading system recommends one or more trading system components to users based on popularity. In some embodiments, popularity of one or more recommendations is based on the opinions of multiple users. Herein, user opinions may be data mined from web platforms including but not limited to social media. However, in other embodiments, users may vote on which cumulative trading strategy, sub-trading strategy, logic engine of the backend, or GUI trading system parameter is the best. Thereafter, the most popular recommendation is recommended to one or more users.

In some embodiments, the trading system or one or more logic engines of or independent of the trading system recommend one or more trading system components to each user based on trading system components that the user has previously used or viewed. One or more users' viewing or use history may be found and interpreted through one or more methods including but not limited to data mining.

Under some embodiments, the trading system or one or more logic engines of or independent of the trading system recommends one or more trading system components to the user because certain market conditions are detected by one or more logic engines of or independent of the trading system. In yet other embodiments, the trading system of one or more logic engines of or independent of the trading system recommends trading system components to users based off factors including but not limited to a user's preferred financial market sector, market industry, asset class, or time of trading.

With the method previously described, a user may view recommended cumulative trading strategies, sub-trading strategies, logic engines of the backend, and GUI trading system parameters. After viewing all the recommendations, the user may select one or more of the recommendations to modify, replace, or build a cumulative trading strategy, sub-trading strategy, logic engine of the backend, GUI trading system parameter or a completely new trading system.

### Graphical Representation of Trade Completion

In one method of the present invention, the amount of time required to execute one or more trades or the time until one or more orders for a trade are sent from an automated trading system, hereafter referred to as the “execution time,” may be portrayed to the user through one or more ways in multiple embodiments described hereafter. In a preferred embodiment, the execution process is graphically displayed to the user through one or more user platforms. Herein, the graphical representation of an execution time for one or more trades may include but is not limited to a loading bar, a loading wheel, a loading circle or any other graphical representation of an on-going or updating process for a trade of a tradeable financial asset. In some cases, the graphical representation of the execution process may display an increase in the execution time at one moment, while then showing a decrease in the execution time in the next moment, depending on different factors affecting the execution of the trade. Factors that may affect a trade include but are not limited to one or more technical analysis, fundamental analysis, event-based, numerical, or statistical studies, observations, occurrences, and/or calculations used to evaluate or analyze a trade.

Under the preferred embodiment of the present invention, the graphical representation of the execution time may also be represented by a number including but not limited to a percentage or a time until the trade is executed. As a non-limiting example, the loading bar may show a graphical representation of 60% as well as the number “60%,” both representing execution time as a percentage relative to a specified or calculated “time scale”, “time frame”, or a past time. Herein, a specified time scale or time frame may include but is not limited to years, months, days, hours, minutes, or seconds. In other embodiments, only a number or only a graphical representation is used to portray to the user the execution time.

In some embodiments, the execution time to place a trade to take a position in one or more financial tradeable assets may be portrayed to the user through other means including but not limited to sound. As a non-limiting example, a user may be alerted with a sound through one or more user devices when a trade is about to be executed. Under some embodiments, the user is notified through one or more user devices with one or more sounds, when the execution time has reached one or more specified points. As a non-limiting example, the user may be alerted with a sound when the execution time is at 6 minutes and then again at 30 seconds.

### Warning Method

Under one method of the present invention, one or more users may be alerted or notified when they use, adjust, or select one or more cumulative trading strategies, sub-trading strategies, logic engines of the backend, or GUI trading system parameters that are incompatible or potentially risky for a specific asset class, asset category or market sector, current market conditions, or future market conditions. In several embodiments, the trading system or one or more logic engines of or independent of the trading system will acquire the knowledge of risk or compatibility through back testing, or forward testing of one or more trading system components. The trading system or one or more logic engines of or independent of the trading system may also acquire the knowledge of risk or compatibility through the data mining of users' automated trading system's performances, or through predefined definition.

When the user makes an incompatible selection or adjustment to one or more cumulative trading strategies, sub-trading strategies, logic engines of the backend or GUI trading system parameters, the trading system will alert the user through one or more trading system graphics, sounds, or other notifications. The user is alerted on one or more users devices, under preferred non-limiting embodiments. In some embodiments, the user will then have the option to continue or discontinue with the selection, adjustment, or use of the one or more incompatible or risky trading system components.

However, in other embodiments, the user will not be allowed to continue with the selection, adjustment, or usage of the one or more cumulative trading strategies, sub-trading strategies, logic engines of the backend, or GUI trading system parameters that is determined to be potentially risky or incompatible. Those versed in the art will readily recognize that by limiting the user's ability to select potentially risky cumulative trading strategies, sub-trading strategies, logic engines of the backend, and/or GUI trading system parameters, the trading system protects the user's account from potentially large losses.

### Method to Show Potential Trades Graphically Based Off of Probability Scores

The present invention comprises another method wherein potential trades for one or more tradeable financial assets are displayed to the user. Herein, potential trades are possible positions that may be taken in one or more tradeable financial assets and that match the requirements of the cumulative trading strategy, sub-trading strategies, GUI trading system parameters, backend and/or a combination of one or more of these trading system components. In some embodiments, potential trades are tradeable financial assets with cumulative scores that are at or above the specified cumulative limit. In other embodiments, potential trades are one or more financial tradeable assets that have met one or more technical analysis, fundamental analysis, event-based, numerical, or statistical requirements.

Under preferred embodiments, the trading system may display potential trades to the user on one or more user devices through one or more trading system graphics including but not limited to text, icons, and the like. In several embodiments, potential trades displayed to the user are in the form of a “list”.

In other embodiments, potential trades may be portrayed to the user through one or more user devices by means including but not limited to sound. In some embodiments, a sound may notify the user when a new potential trade is found. As a non-limiting example, the cumulative trading strategy may find the stock ABC as a potential trade due to its cumulative score and notify the user with an audible sound.

In preferred embodiments, new potential trades or the updated list of potential trades is portrayed to the user in real time. Those versed in the art may realize that new potential trades or the list of potential trades may not always update in real time due to signal latency. In preferred embodiments, the user can manually place a trade of one or more potential trades by performing one or more operations on one or more tradeable financial assets.

Under preferred embodiments of the present invention, the user can also see the current positions being held. Current positions can be seen on one or more pages of the GUI. However, in most embodiments, current positions will be displayed on a separate page within the GUI. If the user views the current positions and wants to exit one or more positions, he or she can do so by performing one or more operations on one or more trading system graphics including but not limited to sell or buy to cover buttons.

In preferred embodiments, “other information” on potential trades and current positions may be viewed by the user if he or she performs one or more operations on one or more trading system graphics. Other information may include but is not limited to charts or fundamental information, such as income statements and financial ratios. Such graphics may include but are not limited to an icon or logo representative of the current position or potential trade. In some embodiments, this icon or log may be the icon or the logo of the company as used in that company's industry.

### Charts

In most embodiments, a user may “click” or “press” (as with a finger) an icon to open a “manual trading page.” Herein, the user may view information including but not limited to charts, technical information, and fundamental information on different asset classes and tickers (as apparent to those versed in the art). In the manual trading page, the user can use one or more scanners, indicators or other non-limiting technical analysis, fundamental analysis, numerical, or statistical events, studies, observations, and/or calculations to analyze different tickers and asset classes. In preferred embodiments, the user can also open, close, and modify one or more positions in one or more financial tradeable assets.

### Saving Strategies

In preferred embodiments of the present invention, a user can save one or more cumulative trading strategies or sub-trading strategies. Once a user saves a trading strategy it is stored in memory, under preferred embodiments. In most cases, the user can perform one or more operations on one or more trading system graphics to select a sub-trading strategy stored in memory and add it to an existing cumulative trading strategy. Similarly, the user can select a cumulative trading strategy to indicate that he or she wants to execute it across one or more financial markets.

### Long/Short Switch

Under one method of the present invention, a user may define one or more cumulative trading strategies, sub-trading strategies, logic engines of the backend, GUI trading system parameters, or the trading system as long or short by performing one or more operations on a short/long switch through a GUI. The short/long switch may include one or more trading system graphics and may be represented by one or more shapes including but not limited to an oval, a rectangle, a square, a circle or a hybrid of these. In some embodiments, the user may “click” or “select” part of the long/short switch graphic to indicate a change from either long to short or from short to long.

Herein, a short/long switch may be used to change one or more cumulative trading strategies', sub-trading strategies', logic engines' of the backend, GUI trading system parameters', or the trading systems' definition from long (short) to short (long), effectively reversing the sentiment, operation, and therefore the trading activity of the trading system component as it contributes to and/or executes the trading process. Those versed in the art will recognize that by being able to switch from long to short, the user may reverse the trading strategy within a very short time period. This capability is at great benefit to the user, as they may need to change the sentiment of their one or more cumulative trading strategies, sub-trading strategies, logic engines of the backend, GUI trading system parameters, or the trading systems from “bullish” (“bearish”) to “bearish” (“bullish”) throughout the trading day as the financial markets change.

### Method to Allocate Capital Using a GUI

In one method of the present invention, a user can allocate capital by performing one or more operations on one or more trading system graphics. The user of the automated trading system can indicate how much capital is to be kept in cash and how much capital is to be kept in positions of tradeable financial assets. Hereafter, the ratio of capital allocated between cash and positions of tradeable financial assets will be referred to as the “capital allocation ratio” or “capital allocation.” A user may indicate and/or control capital allocation through one or more operations on one or more trading system graphics including but not limited to one or more drag options, text boxes, or any other graphics of a GUI. In some embodiments, these trading system graphics, are not only “operational” but they also portray a visual representation of the capital allocation ratio to the user. However, in other embodiments, one or more other trading system graphics will portray the capital allocation ratio to the user. When the user performs one or more operations on one or more trading system graphics, the one or more trading system graphics that the user performed operations on or one or more other trading system graphics will update to show the capital allocation ratio.

In preferred embodiments, the amount of capital allocated to cash and the amount of capital allocated to positions of tradeable financial assets may each be represented by numerical values including but not limited to percentages or currency amounts. In preferred embodiments, these values will be displayed to the user and will update as he or she changes the capital allocation. Under some embodiments of the present invention, the exact numbers of capital allocation for both cash and positions is shown to the user. In preferred embodiments, both numerical values and trading system graphics are displayed to the user to indicate the capital allocation ratio.

When a user indicates capital through the trading system graphics, he or she is telling the automated trading strategy the exact ratio of capital allocation, and under perfect cases, this capital allocation ratio will be kept by the trading system. However, those versed in the art will recognize that sometimes the perfect allocation of cash and positions may not be possible due to uncontrollable factors such as the number of tradeable financial assets required to start a position. As a non-limiting example, positions of 20% of a user's account's capital may be required, but in order to execute this perfectly, the number of shares of a stock would include the fraction of a stock such as 100 and ¼ of a share of stock. In this non-limiting example, it is clear that only 100 shares of stock can be bought, thus making the user-defined capital allocation not exact.

In a non-limiting example of the capital allocation method described above, a user may use a drag-bar to indicate that he or she wants the automated trading strategy to keep 30% of capital in cash and 70% of capital in positions. The user may then execute the automated trading strategy and expect these percentages of capital allocation to be kept within a margin of error.

### Method to Indicate How Much Captial is Short or Long

In one method of the present invention, a user can perform one or more operations on one or more trading system graphics to indicate a number of short positions, long positions, or a ratio of the two, to be opened by an automated trading strategy. In some non-limiting embodiments, an amount or ratio is defined by and/or indicates a percentage of total positions, a currency amount, or a number of positions with sizes either predetermined by the user (or trading system) or calculated by one or more trading system components or other logic engines of the trading system. Under some embodiments, a percentage of total positions may represent and/or indicate a percentage of a currency amount. In yet other embodiments, a number of positions may indicate a number of positions that are each a specified size.

The user can indicate this amount or ratio through one or more operations on one or more trading system graphics, thereby controlling an amount of short positions, long positions, or a ratio of two that an automated trading system opens.

Under some embodiments, one or more trading system graphics that the user performs operations on, or one or more other trading system graphics will portray to the user the number of long and short positions or a ratio of the two. In preferred embodiments, the number of long positions and the number of short positions or a ratio of the two will be portrayed by one or more numerical numbers including but not limited to percentages or currency amounts. In preferred embodiments, these trading system graphics and numerical values will coexist on the GUI and will update automatically when the user performs one or more operations. In some embodiments, the amount and/or number of long (short) positions is changed automatically when the amount and/or number of short (long) positions is changed by the user.

When the automated trading strategy is executed against one or more financial markets, it will open the specific number of short positions (or the amount of capital invested in short positions) and the specific number of long positions (or the amount of capital invested in long positions), or the specific ratio of the two, as defined by the user. However, those versed in the art will recognize that an automated trading strategy may not be able to execute these amounts or the ratio exactly as certain instances may require the strategy to take an impossible position, such as a fraction of a tradeable financial security.

After a user has defined the amount of capital that is long and short or a ratio of the two, he or she may then execute the automated trading strategy across one or more financial markets. In some embodiments, the user may make adjustments to the amount of capital that is long or short or a ratio of the two, while the automated trading strategy is trading across one or more live or simulated financial markets.

As a non-limiting example, a user may indicate the number of short and long positions by selecting and moving a drag bar. Herein, he is adjusting a scroll bar so that 40% of the automated trading strategy's positions are short and 60% of the automated trading strategy's positions are long. The user or one or more trading system components may then execute the automated trading strategy against one or more financial markets and expect the percentages of long and short positions to be kept within a certain margin of error.

### Method to Define (Using a GUI) How Much Capital Should be in Each Position

Under one method of the present invention, the amount of capital allocated to one or more positions of a tradeable financial asset by an automated trading strategy is defined by the user through one or more operations on one or more trading system graphics. In preferred embodiments, the amount of capital allocated to one or more positions of a tradeable financial asset is represented by number including but not limited to a currency amount. In other embodiments, the number representing the amount of capital allocated to one or more positions includes but is not limited to a percentage of user capital or a percentage of the amount of capital that a user wants to allocate to trading.

Herein, when the user performs one or more operations on one or more trading system graphics, he or she is telling the automated trading strategy to allocate a specified amount to each position. As a non-limiting example, a user may drag a trading system graphic on a drag bar (another trading system graphic) to indicate that only $1500 should be allocated to each position.

In some embodiments, one or more trading system graphics may exist on the GUI that allow the user to define the amount of capital that should be allocated to one or more kinds of positions, hereafter referred to as “position type(s),” including but not limited to short positions, long positions, hedge positions or any other type of position of a tradeable financial asset as known to those versed in the art. “Hedge positions” include positions opposite of current positions held (such as a short position to hedge a long position), options positions, or any other position used to hedge a current position as recognized by those versed in the art. These trading system graphics or one or more other trading system graphics may also portray to the user the amount of capital to be allocated to each position type. In yet other embodiments, the actual amount of capital in each position may be portrayed to the user through one or more trading system graphics. As a non-limiting example, a user may adjust a trading system graphic on the GUI to indicate that $4,000 should be allocated to each long position. The user may then adjust another trading system graphic to indicate that $3,000 should be allocated to each short position.

After a user has defined the amount of capital that is to be allocated to the each position, he or she or one or more trading system components may then execute the automated trading strategy across one or more financial markets. In some embodiments, the user may make adjustments to the amount of capital assigned to each position, while the automated trading strategy is operational in one or more financial markets.

When the automated trading strategy is executed across one or more markets, it will allocate the user defined amount(s) of capital to each position. Under ideal cases, this amount will be exact and will not exceed the user's definition of capital allocation to each position. However, in some embodiments, a certain amount of error may be allowed. For example, a user's settings may indicate that $400 is allocated to each long position. However, if a position of a certain tradeable financial asset is to cost $402.16, the position may still be taken. In some non-limiting embodiments, this error may be defined within the trading system as a percentage of the position or as a fixed currency amount. In yet other embodiments, the one or more trading system components may calculate this error as well as update the error depending on market factors including but not limited to volatility and market risk.

### Method to Define How Much Leverage is Used Per Position

Under another method of the present invention, the “amount of leverage” used when taking one or more positions of a tradeable financial asset by an automated trading strategy is defined by the user through one or more operations on one or more trading system graphics. Those versed in the art will recognize that the amount of leverage used to take a position of a tradeable financial asset is a loan from one or more entities including but not limited to a brokerage firm. In preferred embodiments, the amount of leverage used to take a position of a tradeable financial asset is represented by one or more numbers including but not limited to a currency amount or a percentage of the cost of the position. In preferred embodiments, one or more numbers are portrayed to the user through the GUI.

With the current method, a user can perform one or more operations on one or more trading system graphics to define how much leverage is used when taking each position, including but not limited to each position type. In some embodiments, the user can define the amount of leverage used for the whole automated trading strategy. Those versed in the art will recognize that the amount of leverage used for the whole automated trading strategy may affect the number and/or the size of each short and long position depending on the user-defined amount of leverage for each.

In preferred embodiments, the trading system graphics that the user performs one or more operations on, portray to the user the amount of leverage for all positions, long positions, and/or short positions. However, in other embodiments, trading system graphics that the user does not perform operations on (to adjust the amount of leverage) portray to the user the amount of leverage for all positions, long positions, and short positions. In many embodiments, the amount of leverage for short (long) positions is updated when the amount of leverage for long (short) positions is changed by the user. In some embodiments, the amount of leverage actually being used by the automated trading strategy for all, short and long positions is updated in real time or in an amount of time with any amount of latency.

As a non-limiting example, a user may drag a trading system graphic on a drag option within the GUI to indicate that 40% leverage needs to be used when taking each short position. The user may then drag another trading system graphic on a drag option of the GUI to indicate that 60% leverage needs to be used when taking each long position. In some embodiments, the automated trading strategy is executed across one or more financial markets by the user, after the user has defined how much leverage is used for each trade. However, in other embodiments, the automated trading strategy may be operating across one or more financial markets while the user is adjusting the amount of leverage to be used in each position.

When the automated trading strategy is executed across one or more financial markets to take one or more short or long positions of tradeable financial assets, the automated trading strategy will use the amount of leverage for all positions and/or each position (long or short) as defined by the user through the GUI. Under some embodiments, the automated trading strategy may allow and use an error range of the user defined leverage requirements. As a non-limiting example, a position of 40 shares of a given stock may need to be taken by the automated trading strategy in order to meet other settings of the automated trading strategy. If the user only has cash for taking a position of 39 shares, then the trade may still be taken using slightly more leverage.

### Method to Define How Long a Position Should be Held

In one method to the present invention, the amount of time that a position is held or kept by an automated trading strategy is hereafter referred to as “holding time,” can be defined by the user's one or more operations on one or more trading system graphics. In preferred embodiments, the holding time is represented by one or more numbers including but not limited to seconds, minutes, hours, days, months, or years.

Under the current method, a user may perform one or more operations on one or more trading system graphics to indicate how long a position of a tradeable financial asset should be held. In preferred embodiments, the user can indicate a holding time for short positions, long positions, and hedge positions. Those versed in the art will recognize that hedge positions are positions used to minimize the risk of a user's current position. In some embodiments, the holding time indicated by the user may be uniform for one or more short, long, or hedge positions. In some embodiments, a user can perform one or more operations on one or more trading system graphics to indicate whether the automated trading strategy holds positions “over-night,” “over the weekends,” or “until the end of afterhours trading.” It will be apparent to those versed in the art that “over-night” means during the time between trading days and that “over the weekends” means over the days of Saturday and Sunday for one or more specified time zones.

After the user has defined the holding time for the automated trading strategy, he or she may execute the automated trading strategy across one or more financial markets. In some embodiments, the user may define the holding time by adjusting one or more trading system graphics during live operation of the automated trading strategy, and the automated trading strategy will automatically adjust to and be defined by the new holding time requirements.

### Method to Adjust a Graphical User Interface to Hedge a Position

Under one method of the present invention, a user may perform one or more operations on one or more trading system graphics to define “when” hedge positions are taken, the “size” of hedge positions, and the “type” of hedge positions taken and held by an automated trading strategy.

Under some embodiments, a user can perform one or more operations on one or more trading system graphics, to define the “type” of hedge positions used by the automated trading strategy to hedge one or more of the automated trading strategy's current positions. The type of hedge position will hereafter be referred to as the “hedge type.” Hedge types can include but are not limited to one or more positions opposite of the one or more “current positions” (positions already held by the automated trading strategy), hereafter referred to as “opposite positions.” Opposite positions can include but are not limited to short positions taken to hedge a long position or long positions taken to hedge a short position. As a non-limiting example, the user may drag a trading system graphic on a drag bar to indicate that short positions may be taken to hedge a long position. The user may then perform on or more operations on one or more other trading system graphics to further indicate that a short position should be taken only after the decline of the financial tradeable asset of the long position.

Those versed in the art will also readily recognize that hedge type can also include but is not limited to an options position. Options positions can include puts, calls, American options, European options, and exotic options, as non-limiting examples. In one non-limiting example, a user may click a switch to indicate that puts may be bought to hedge a long position.

In preferred embodiments, the hedge type may also include but is not limited to a position in a different market sector or asset class. As a non-limiting example, the user can press a button to indicate that the automated trading strategy should take short positions in the technology sector as hedge positions.

In preferred embodiments, a user may adjust the “size” of the hedge position relative to the current position, hereafter referred to as the hedge size. The hedge size can include a currency amount or a percentage of the current position. As a non-limiting example, a user may adjust a trading system graphic to 30%, indicating that sizes of hedge positions should be 30% of each current position. However, in another non-limiting example, the user may adjust the size of a hedge position to be $1,000.

In preferred embodiments of the present invention, the user may also define “when” each hedge position is opened by an automated trading strategy. “When” a hedge position is opened may include but is not limited to a specific time after the current position is taken, a specific time during the trading day, after one or more market events, or at any other time defined by the user. As a non-limiting example, the user may select and adjust a drag option to define that a hedge position should be taken half-way through the trading day. “When” a position is opened, may also include but is not limited after one or more technical analysis, fundamental analysis, numerical, or statistical events, studies, observations, and/or calculations have occurred for a given tradeable financial asset. In one non-limiting example, a user may perform one or more operations on one or more trading system graphics to indicate that a hedge position should be opened by the automated trading strategy after the financial tradeable asset of the current position has had a confirmation of a bearish engulfing pattern.

After a user has defined the hedge type and the hedge size as well as “when” a hedge position should be taken, he or she may execute the trading strategy across one or more financial markets. In some embodiments, the user may adjust the “type” and “size” of a hedge position as well as “when” a hedge position should be taken, during live operation of the automated trading strategy, and the automated trading strategy will automatically adjust and be defined by the new requirements. However, under other embodiments, the user can only adjust the “type” and “size” of a hedge position as well as “when” a hedge position should be taken when the automated trading strategy is not operational across one or more financial markets.

### Method to Close or Hedge Positions in Emergency

Under one method of the present invention, the user may perform one or more operations on one or more trading system graphics to indicate if a position of a financial tradeable asset should be automatically closed, reduced in size, added-to, hedged, or a combination of these four actions by the trading system. In preferred embodiments, a position can be closed, reduced in size, added-to, hedged or a combination of the four, if one or more market conditions are detected, if the cumulative score of the financial tradeable asset falls below the cumulative limit, and/or if a specified or calculated “risk level” for one or more financial markets, financial market sectors, asset classes or industries is detected. These occurrences will hereafter be referred to as “phenomena.” Risk levels may include but are not limited to levels of risk as determined by one or more trading system components. Those versed in the art may recognize that the one or more market conditions and/or the one or more risk levels may depend on the asset class or the type of position (short, long, or options position).

In some embodiments, the user may perform one or more operations on one or more trading system graphics to indicate which phenomena require the trading system to perform which of the following actions: to close, reduce in size, add-to, hedge a position or a combination of these actions. As a non-limiting example, a user may “press” a button to indicate that position should be closed out if cumulative scores fall below the cumulative limit. In preferred embodiments, the user may perform one or more operations on one or more trading system graphics to indicate the one or more risk levels or financial market conditions for which positions should be closed or hedged. In some embodiments, the trading system or one or more trading system components will monitor the cumulative scores of the financial tradeable assets for one or more or the totality of the positions held by the automated trading strategy of the user.

In one non-limiting example, a user may select a “bubble fill” to indicate that positions should be closed out if the cumulative score falls below the cumulative limit. In another non-limiting example, the user may “click” a switch to indicate that short positions should be closed if a market rally is detected.

In some embodiments, one or more logic engines of the trading system may determine the one or more risk levels or market conditions for closing, reducing in size, adding-to, or hedging a position. Under some embodiments, if one or more phenomena occurs, then one or more logic engines of the trading system may automatically determine to reduce in size, close, add-to, or hedge one or more of the positions held by the automated trading system and do so automatically.

If a cumulative score for a financial tradeable asset does fall below the cumulative limit, a certain market condition is detected, or risk level is detected; then the trading system may take one or more actions including but not limited to reducing the size of, closing, add-to, or hedging the position as defined by the user or determined by one or more logic engines of the trading system.

### Method to Adjust a Trading Model Using a Graphical User Interface

In one method of the present invention, a user can perform one or more operations on one or more trading system graphics to adjust one or more algorithmic or quantitative models, hereafter referred to as “algorithmic models.” Herein, an algorithmic model may include but is not limited to one or more technical analysis, fundamental analysis, event-based, numerical, or statistical models comprising one or more lines of code.

In preferred embodiments, algorithmic models may be of an automated trading strategy or system. When a user performs one or more operations on one or more trading system graphics to adjust one or more algorithmic models, the user is re-defining the model used within the automated trading strategy. As a non-limiting example, the user may adjust an ascending triangle algorithmic model to 70%, thereby defining the ascending triangle to be 70% of its original definition.

After a user has adjusted the model, the user may then execute the automated trading strategy across one or more financial markets. In some embodiments, the user may only adjust one or more algorithmic models when the automated trading strategy is not operating across one or more financial markets. However, in preferred embodiments, the user can perform one or more operations on one or more trading system graphics to adjust one or more algorithmic models during live operation of the automated trading strategy, and the automated trading strategy will automatically adjust and be defined by the new requirements.

### Method to Define When a Trading System or Automated Trading Strategy Trades

Under one method of the present invention, the user can perform one or more actions on one or more trading system graphics to define “time(s) of operation” for an automated trading strategy. Times of operation are times when the trading strategy is operational across one or more financial markets and include but are not limited to at a certain time of a day, a week, a month, a year, or a season. As a non-limiting example, a user could “click” a button to indicate that a trading strategy should only operate between the times of 9:30 and 11:00 A.M. Times of operation can also include but are not limited to during or after specified market events, or any other times known by those versed in the art. For example, a user may “click” or “press” (as with a finger) a switch to indicate that a short trading strategy can only trade during a market decline.

In preferred embodiments, the user may define times of operation for multiple trading strategies saved by the user. In some embodiments, the user can indicate one or more times of operation for all trading strategies, where after, each trading strategy updates with respect to the one or more times of operation for all trading strategies. Under preferred embodiments, one or more trading system graphics representing each trading strategy will also update accordingly when

### Auto-Building of Strategies

Under one method of the present invention, one or more cumulative trading strategies, sub-trading strategies, logic engines of the backend and/or GUI trading system parameters may be developed automatically by one or more logic engines of or independent of the trading system. One or more trading system components may be developed in response to conditions including but not limited to one or more financial market conditions or changes in one or more financial markets. As a non-limiting example, a shorting, sub-trading strategy may be developed in response to declining markets.

In some embodiments, one or more cumulative trading strategies, sub-trading strategies, logic engines of the backend and/or GUI trading system parameters are developed by the automated writing of one or more lines of code by one or more logic engines of or independent of the trading system. Once a new trading system component is developed it may be recommended to the user. In some embodiments, the one or more trading system components may be automatically installed in the trading system during live or simulated trading. However, in other embodiments, one or more trading system components may be installed in the trading system only when the trading system is not trading.

Under some embodiments, one or more logic engines of or independent of the automated trading system may develop a new sub-trading strategy by automatically adjusting the sub-trading strategy's strategy limits. Those versed in the art will recognize that by adjusting the strategy limits a new sub-trading strategy is developed. Once the new sub-trading strategy is developed it may be recommended to the user. However, in some cases the new sub-trading strategy may be back and/or forward tested before it is recommended to the user.

In some embodiments of the present invention, one or more logic engines of or independent of the automated trading system adjust one or more components of one or more backend logic engines to develop one or more new logic engines of the backend. Components or factors of the backend may include but are not limited to risk levels, loss levels, definitions of risk, and definitions of how to manage risk or loss. Those versed in the art will recognize that there are countess definitions of and how to manage or define both risk and loss, and are also subject to the user's view of the markets.

In other embodiments, one or more logic engines of or independent to the automated trading system automatically develops one or more cumulative trading strategies by the selecting and weighting one or more sub-trading strategies, as well as adjusting one or more sub-trading strategies' strategy limits. Herein, one or more logic engines of or independent of the trading system are creating a new cumulative trading strategy.

After a cumulative trading strategy, sub-trading strategy, logic engine of the backend or GUI trading system parameter is developed by the non-limiting methods described above, it can be recommended to the user. In other instances, the new cumulative trading strategy, sub-trading strategy, logic engine of the backend, and/or GUI trading system parameter may be automatically installed in the user's trading system while the trading system is being executed across one or more financial markets. Installations may be in response to factors including but not limited to market conditions, market sector conditions, “user trading behavior” and any other non-limiting condition and the like. Those versed in the art will recognize that “user trading behavior” is how the user builds and adjusts the trading system.

### AI (Articial Intelligence) Trading Method

In one method of the present invention, one or more trading system components or one or more other logic engines of or independent to the trading system may autonomously build and change the trading system by selecting and/or deselecting one or more trading system components. In some embodiments, one or more trading system components may be built, modified or replaced by one or more of the methods previously described in the present invention. This processes may be done without any user interference in preferred embodiments. However, in some embodiments, the user may perform one or more operations on one or more trading system graphics to adjust this process. The one or more trading system components or one or more logic engines of or independent to the trading system that build, replace, or modify the trading system, the other trading system components or measure market factors to do so, will hereafter be collectively referred to as the “AI system” or “Artificial Intelligence System.”

In preferred embodiments, the building, modifying, and replacing of the trading system or one or more trading system components will be executed in order to create a trading system that is optimal for current or future market conditions, as indicated by one or more factors of the financial markets, financial market conditions, or tradeable financial assets hereafter referred to as “market factors.” Market factors may include but are not limited to a change in the value of one or more indexes, the change in the value of one or more individual tradeable financial assets, or one or more changes in a trading system component's performance, or any other factors that may indicate a change in one or more financial markets or a portion of one or more financial markets, known to those versed in the art.

In one embodiment, a trading system component's performance may be indicated by a change in its “score” for each of a large or statistically significant number of tradeable financial assets. These “scores” include the cumulative scores for cumulative trading strategies and the sub-scores for sub-trading strategies. Scores may also include but are not limited to scores for other trading system components, representative of those other trading system components' performances with one or more financial tradeable assets.

In yet other embodiments, the AI system may automatically test the market with one or more cumulative trading strategies, sub-trading strategies, logic engines of the backend, GUI trading system parameters, or trading systems through paper-trading or by executing multiple small orders across one or more financial markets to determine which of these trading system components or trading systems is best suited for the current or future market conditions. The AI system may then observe, measure, and record the effects of the test trading. Under one embodiment, the AI system will score the results of the testing performed, producing “test scores.”

Herein, scoring the results may be done through one or more statistical, numerical, or other mathematical methods. In preferred embodiments, predetermined or automatically calculated thresholds exist for each test score of each trading system component, and will hereafter be referred to as “test score threshold(s).” In some embodiments, the AI system may calculate the test score threshold for each trading system component based on one or more factors including but not limited to market conditions or for any other factor known to those versed in the art. In preferred embodiments, only a trading system component with test scores equal to or above predefined or the automatically calculated test score threshold will be used to build, modify, or replace the trading system.

Under some embodiments, the AI system may find the need to completely replace one or more trading system components that are in use with one or more other trading system components, respectively. The AI system may also halt trading or clear and/or hedge positions during an emergency financial situation.

As a non-limiting example, the AI system may pick three sub-trading strategies and weight them to develop a cumulative trading strategy for the current market conditions. The one or more logic engines of the AI system may choose the ascending triangle, Bollinger band expansion, and money flow sub-trading strategies and weight them at 35%, 40%, and 25% for bullish market conditions. The AI system may then set the GUI trading system parameters of the cumulative trading strategy including the strategic limits of the sub-trading strategies. Hereafter, the one or more algorithms of the AI system may then execute the cumulative trading strategy against one or more financial markets. If the markets change throughout the trading day, the AI system may change the cumulative trading strategy by substituting out one or more of the sub-trading strategies being used, or change the trading system by changing one or more of the GUI trading system parameters.

### Round-Trip Counter

Under one method of the present invention, one or more logic engines or other trading system components of or independent to the trading system count the number of times a position is entered and exited by the trading strategy in the same trading day. Those versed in the art will readily recognize that a position entered and exited in the same day is considered a “round-trip.” In preferred embodiments, the trading strategy will stop trading when a specified or calculated number of round trips has occurred. In yet other embodiments, the trading system will alert the user when a specified or calculated number of round trips has been reached by the trading strategy.

### Autonomous Combinations

Many of the methods and tasks of the present invention, as performed by the user, may be completely automated when performed by one or more logic engines of the trading system. Also, many of the methods and tasks of the present invention that are preferably performed by one or more logic engines, may be performed by the user under some embodiments.

Those versed in the art will recognize that the one or more methods and tasks described under the present invention may be completely automated, left to the user, or a combination of these two. It should also be obvious to those versed in the art that some methods and tasks of the present invention can be left to the user while other methods and task can be completely automated. As non-limiting examples, one or more logic engines of the trading system may adjust the capital allocation ratio, whether a trading strategy is long or short, or the amount of leverage used for each trade. Furthermore, the user may determine which sub-trading strategies are used and how much capital is short, as non-limiting examples.

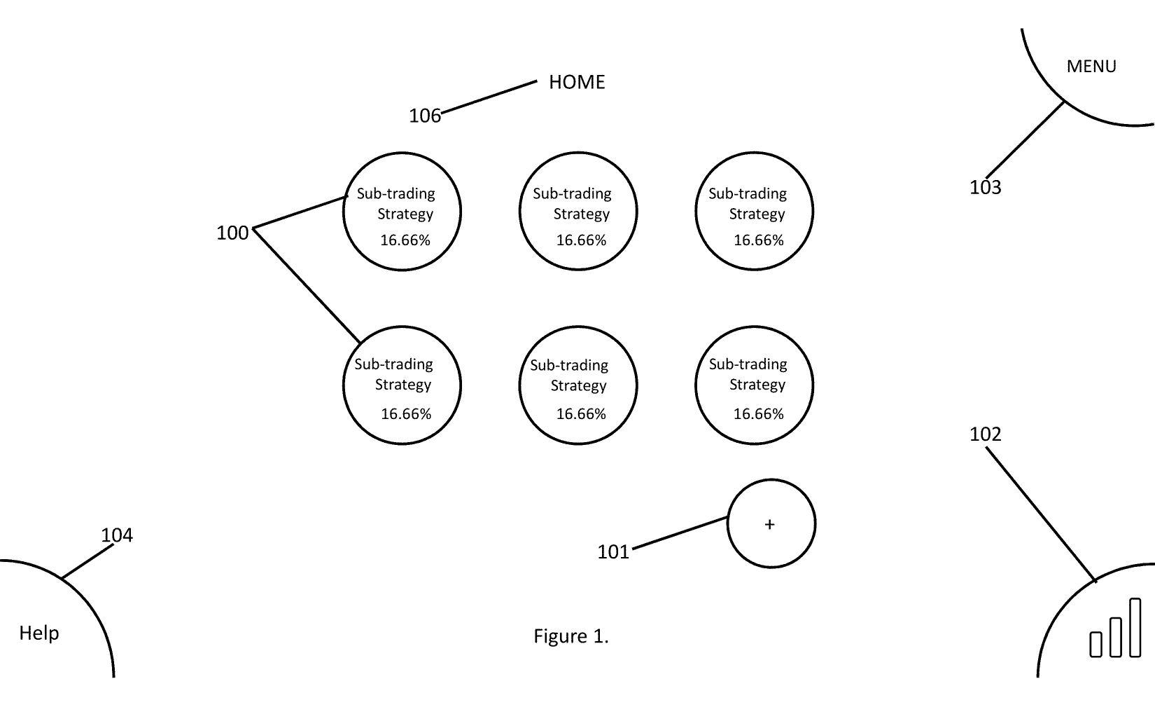

A home page containing multiple sub-trading strategy's is illustrated in FIG. 1. Therein each sub-trading strategy 100 is weighted equally so that each is equally valued within the cumulative trading strategy. The user can “select” or “click” the selections page's unique trading system graphic 101 on the home page 106 to access the selections page 107. The user can also access to other pages or windows within the trading platform through the help, menu, and charts, pages 104, 103, 102.

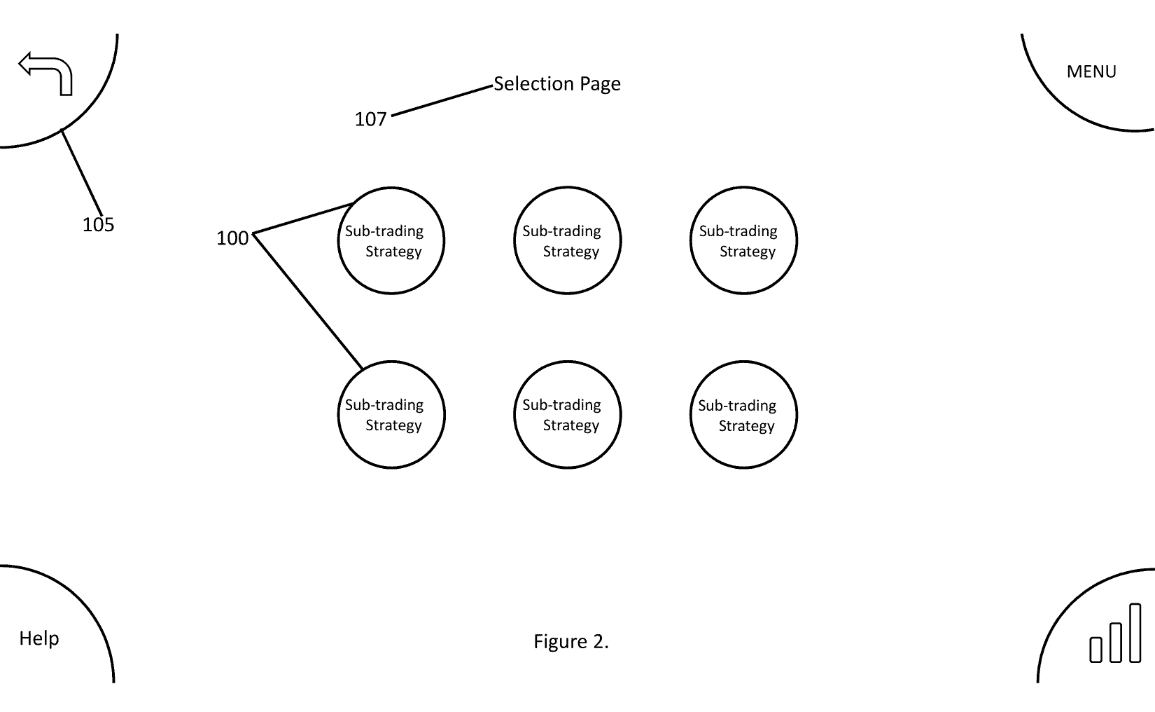

The user can “click” or “select” one or more sub-trading strategies 100 within the selections page 107 to add them to the cumulative trading strategy as illustrated in FIG. 2. When the user does, click or select a sub-trading strategy 100, it is automatically added to the cumulative trading strategy under preferred embodiments. Also illustrated in FIG. 2, the user can click the “back button” 105 to go back to the home page 106.

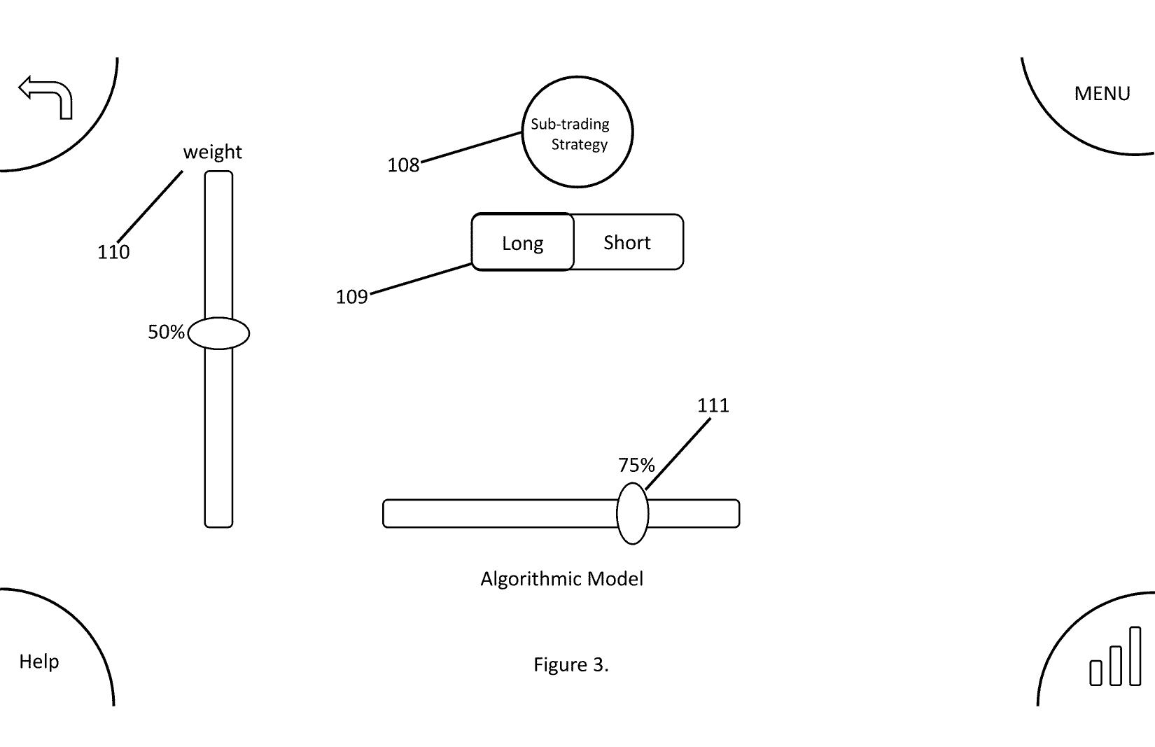

When the user does select a sub-trading strategy from the home page, he or she is taken to the sub-trading strategy's setting's page in preferred embodiments as illustrated in FIG. 3. Herein the user can adjust multiple GUI trading system parameters of the sub-trading strategy including but not limited to whether the sub-trading strategy is short or long using a short/long switch 109. The user can also adjust the weight of the sub-trading strategy 110 and the algorithmic model for the sub-trading strategy 111.

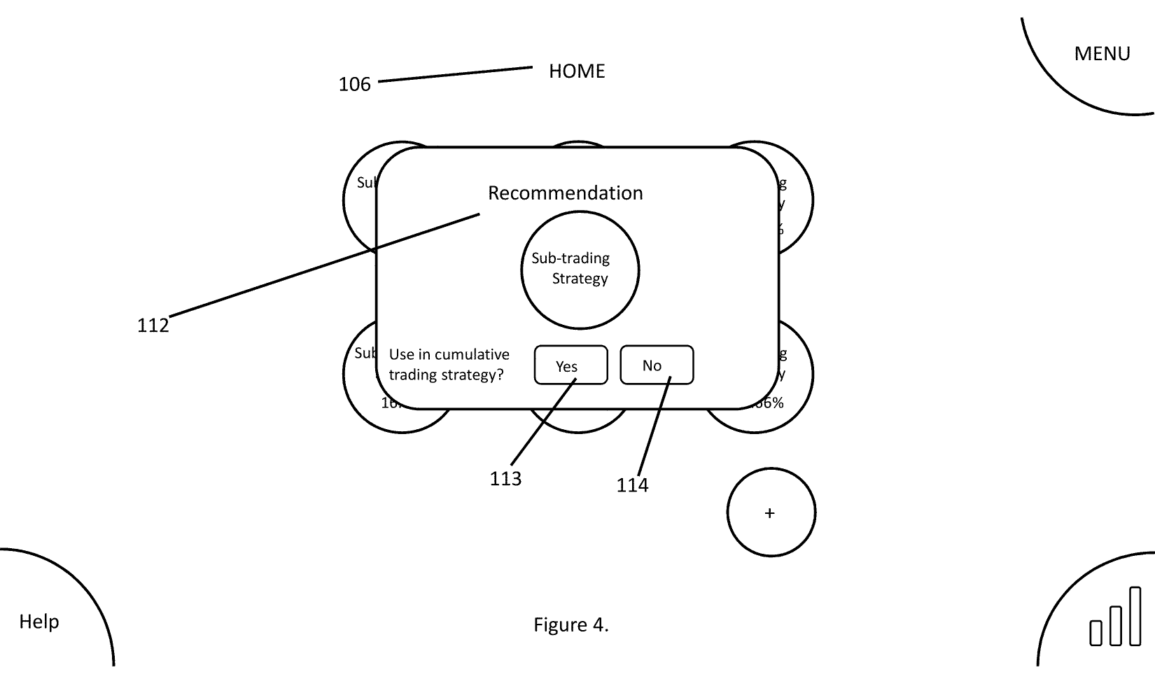

The trading system or one or more logic engines of or independent of the trading system can recommend one or more cumulative trading strategies or sub-trading strategies as illustrated in FIG. 4. Herein, the trading system is portraying a recommendation 112 to the user by displaying a pop-up on the home page 106. The user can then “click” or “select” the “yes” button 113 or “no” button 114 to use or reject the recommendation 112.

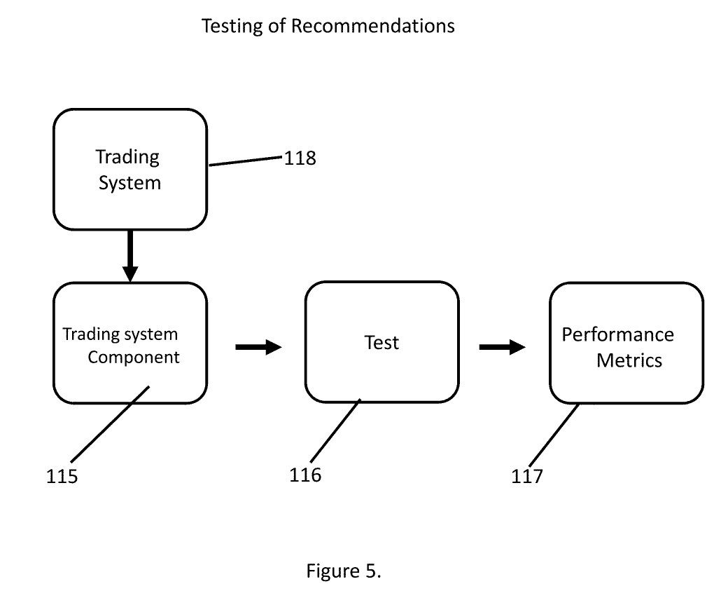

In order to find which trading components should be recommended to the user, the trading system 118 may first put the trading system component 115 through a test 116 as illustrated in FIG. 5. The trading system 118 may then receive performance metrics 117 from the test 116.

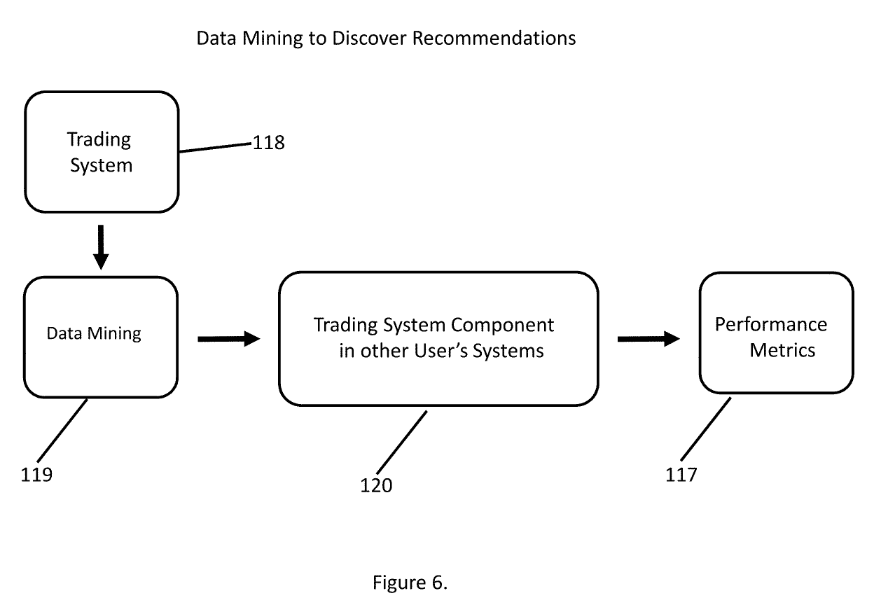

As illustrated in FIG. 6 the trading system 118 can data mine 119 other user's trading system components 120 and those trading systems components' performances to find out which is most optimal for the current market conditions. In preferred embodiments, the trading system receives performance metrics 117 from the data mining 119.

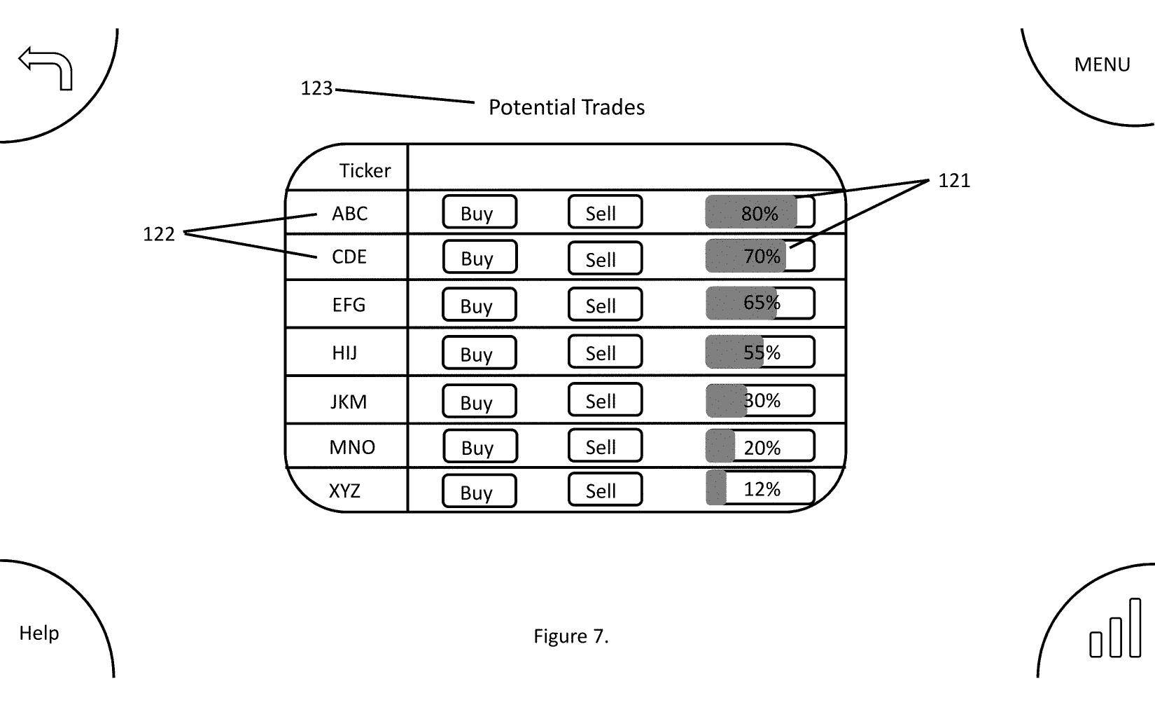

Potential trades 122 may be illustrated to the user through a potential trades page 123 within the graphical user interface of the trading platform as illustrated in FIG. 7. The user can also view the execution time as a percentage of a certain time period or time frame through a loading bar 121 in some embodiments. Under preferred embodiments, the loading bar 121 will update in real time to display “how close” a position is to being opened or “when” that position is being opened.

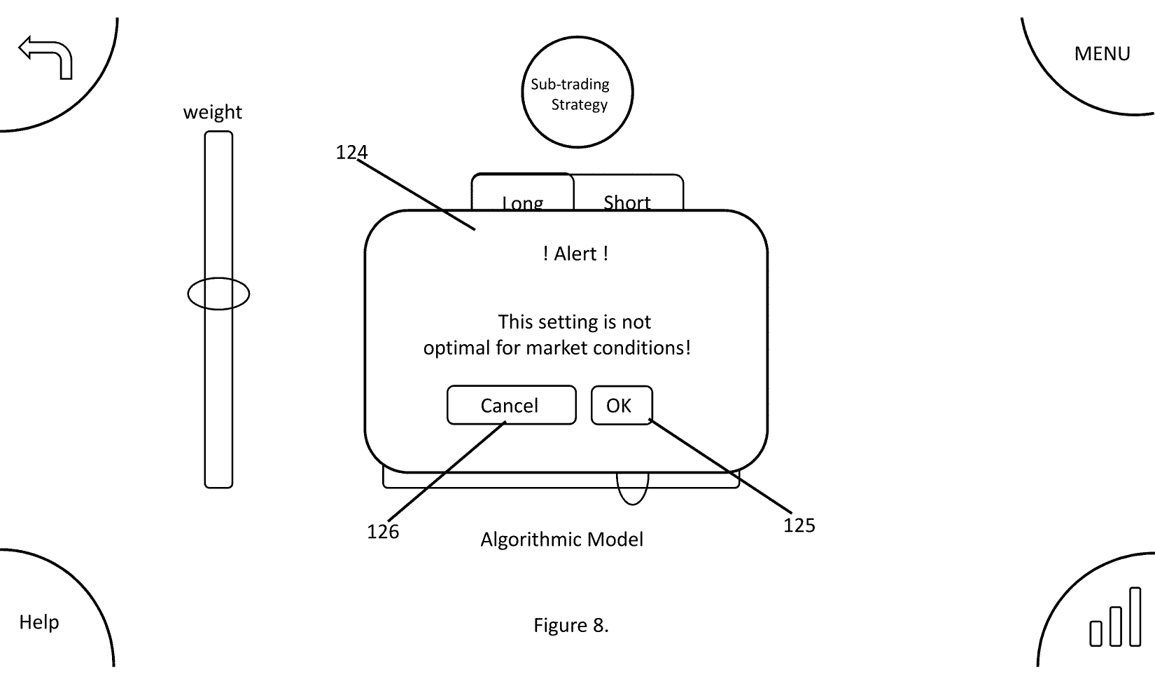

The user may be alerted when he or she makes an adjustment to a GUI trading system parameter that is considered risky or incompatible with current or future market conditions as illustrated in FIG. 8. The trading system can display an alert pop-up 124 to the user, alerting him of the incompatible GUI trading system parameter adjustment. The user can then “click” or “select” the “cancel” button 126 to cancel the adjustment or the “ok” button 125 to continue with the adjustment.

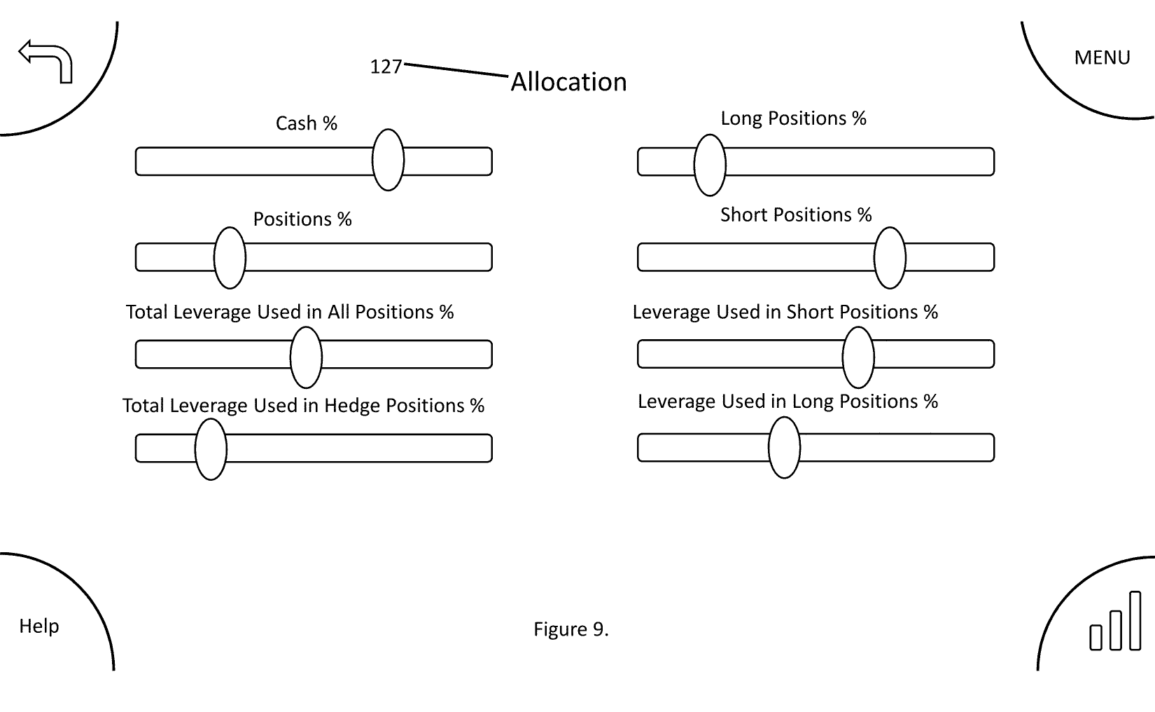

Through the graphical user interface the user can adjust allocation settings as illustrated in FIG. 9. Under some embodiments these settings are local to one page called the allocations page 127. The user can adjust percentage or amount of leverage used for taking, short positions, long positions, all positions or hedge positions. In preferred embodiments, the user can also adjust the ratio of or percentage of cash, positions, short positions and long positions relative to each other or to the total allocation of the trading system or trading strategy.

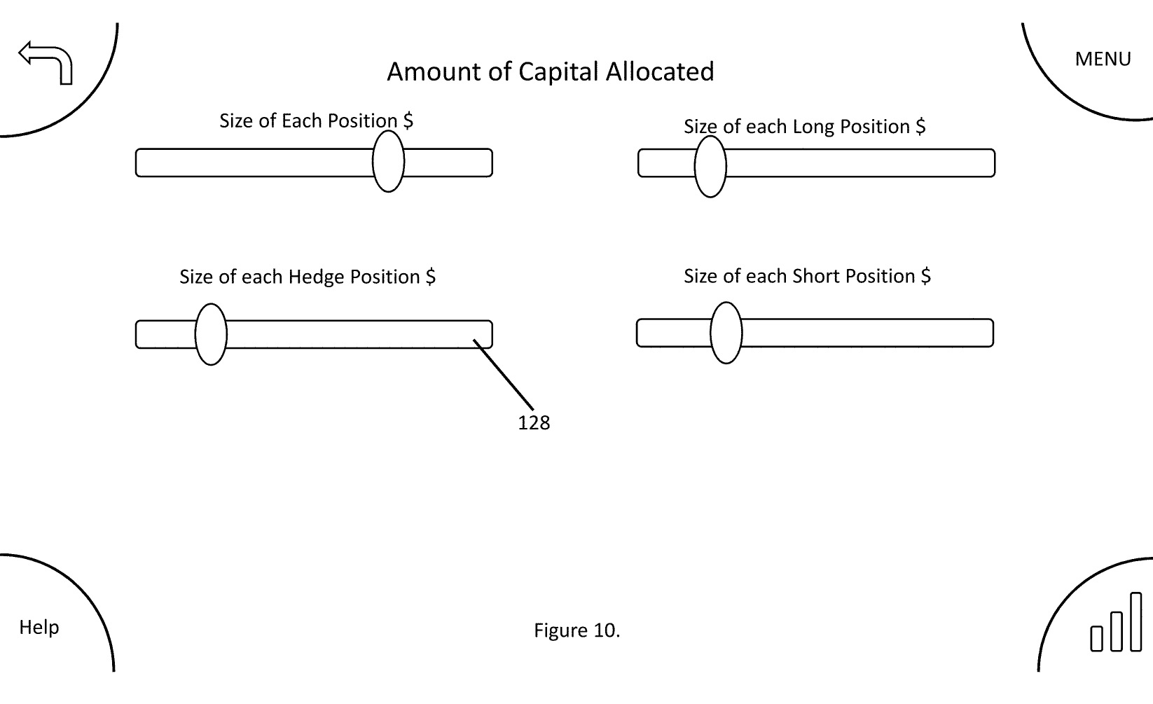

The user can also adjust the amount of capital allocated to each position as illustrated in FIG. 10. The user can also adjust the amount of capital allocated to each long, short, or hedge position opened by the trading strategy. Herein, when the user adjusts one or more of the levers 128, he or she is indicating the amount of capital to be spent on a position or the “cost” of a position.

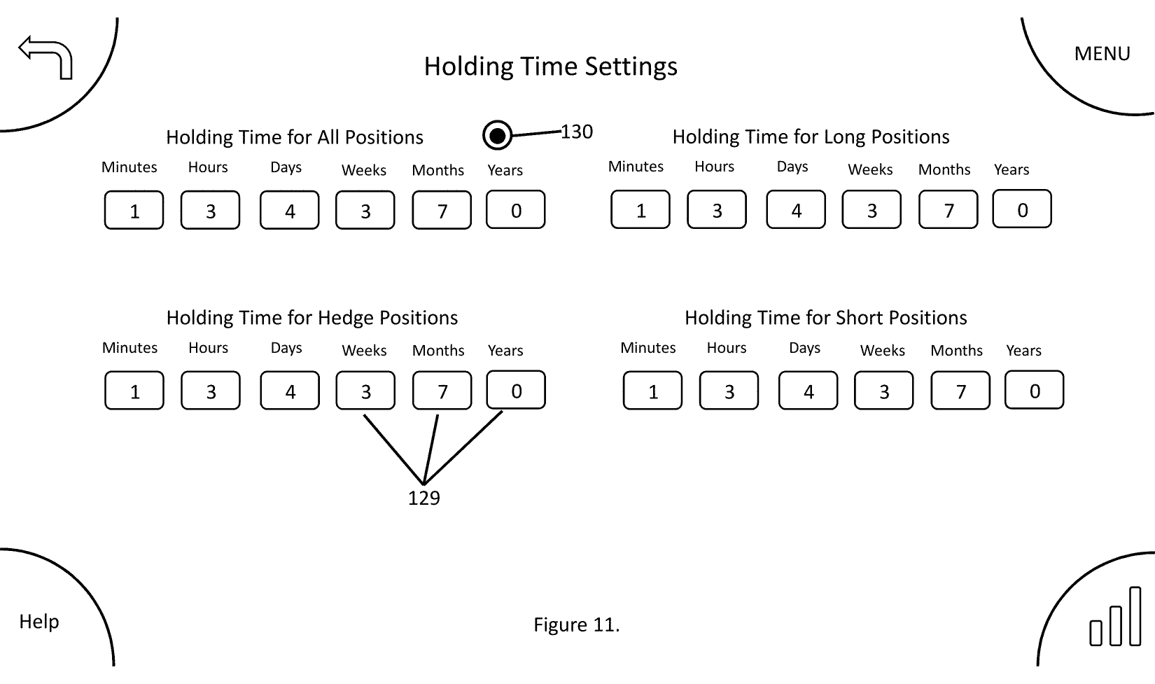

The user can adjust the holding time for one or more positions and position types as illustrated in FIG. 11. To change, define, or adjust the holding time the user can enter the number of a specified time period such as a day or an hour in one or more of the text boxes 129. Under some embodiments, the user can “select” the “Holding Time for All Positions” 130 to set a single holding time for all positions taken by the trading strategy.

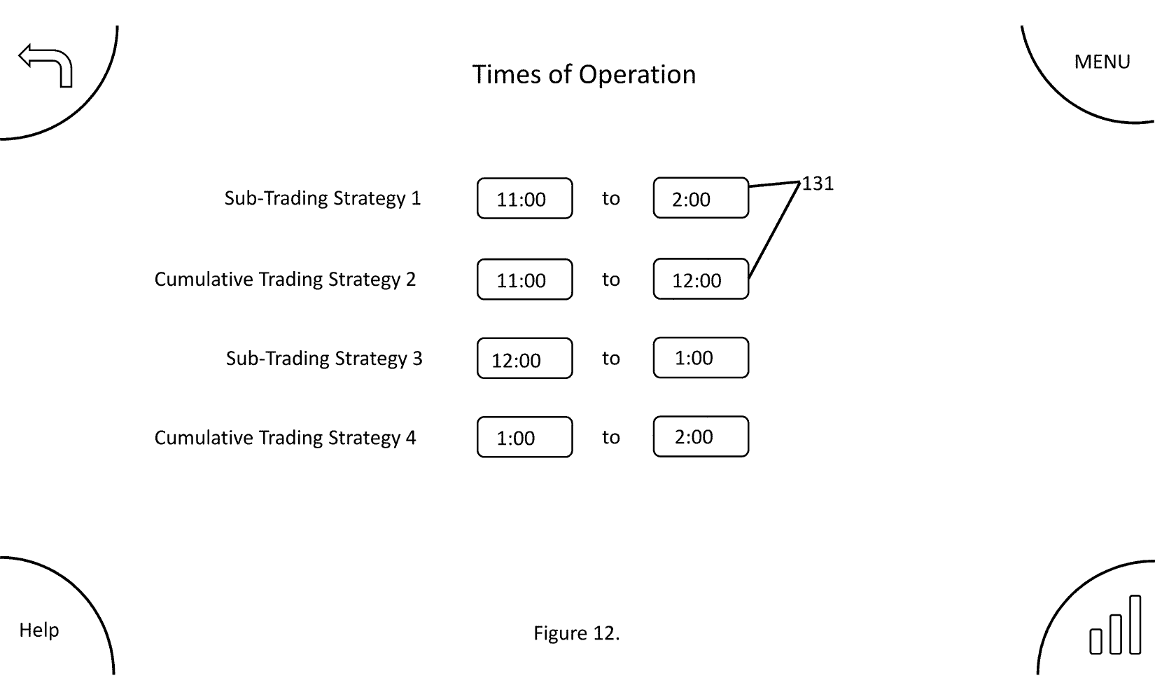

Under one method of the present invention, the user can set, define, adjust, change, or replace the times of operation for one or more trading strategies. As illustrated in FIG. 12, the user can enter an amount of time into one or more of the text boxes 131. When the user enters a time into one of these text boxes, he is defining the a specified time period for which the trading strategy will trade.

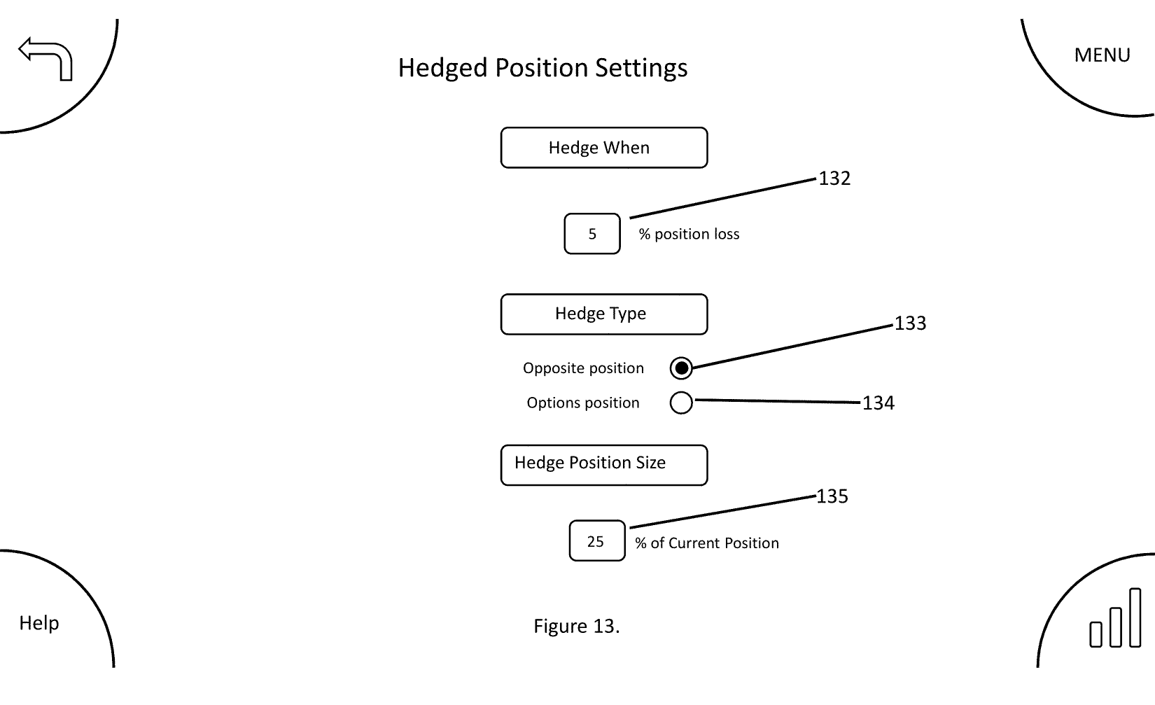

Under one method of the present invention, the user can adjust the size of, the type of, and when a hedge position is taken by a trading strategy by performing one or more operations on one or more trading system graphics. As illustrated in FIG. 13, the user can enter the number “5” into a text box 132, to define that a hedge position can be opened when the loss of a current position is at 5%. The user can also select either the “opposite position” option 133 or the “options position” option 134 to indicate the type of hedge position to be opened. To indicate the positions size, the user can enter a number into the text box 135 such as “25” to define that hedge positions opened need to be 25% of the current position.

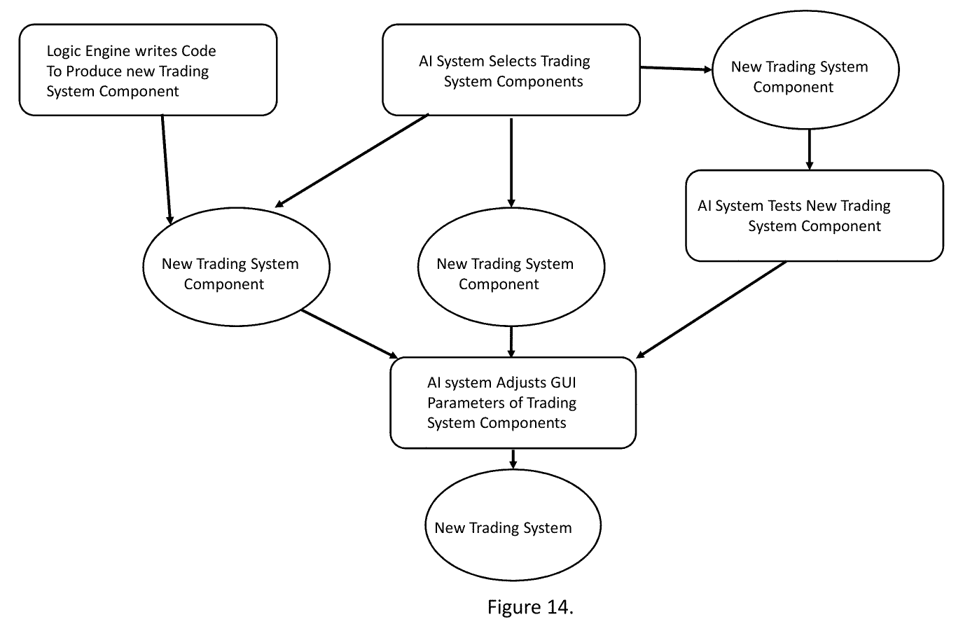

The operation of an AI system is illustrated in FIG. 14. Herein, the trading system can build a new trading system or trading system component by selecting different trading system components. The AI system can also adjust one or more GUI trading system parameters to further build the new trading system component or new trading system. In some embodiments, the AI system or one or more logic engines of or independent of the AI system may write one or more lines of code to produce a new system component. Once a new trading system component is produced, developed or built, the AI system may test the trading system component before it is added to the new trading system.

An exemplary system for implementing the various software aspects of the invention includes a computing device or a network of computing devices. In a basic configuration, computing device may include any type of stationary computing device or a mobile computing device. Computing device typically includes at least one processing unit and system memory. Depending on the exact configuration and type of computing device, system memory may be volatile (such as RAM), non-volatile (such as ROM, flash memory, and the like) or some combination of the two. System memory typically includes operating system, one or more applications, and may include program data. Computing device may also have additional features or functionality. For example, computing device may also include additional data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules or other data. System memory, removable storage and non-removable storage are all examples of computer storage media. Non-transitory computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other physical medium which can be used to store the desired information and which can be accessed by computing device. Any such computer storage media may be part of device. A computing device may also have input device(s) such as a keyboard, mouse, pen, voice input device, touch input device, etc. Output device(s) such as a display, speakers, printer, etc. may also be included. Computing device also contains communication connection(s) that allow the device to communicate with other computing devices, such as over a network or a wireless network. By way of example, and not limitation, communication connection(s) may include wired media such as a wired network or direct-wired connection, and wireless media such as acoustic, RF, infrared and other wireless media.

Computer program code for carrying out operations of the invention described above may be written in a high-level programming language, such as C or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller. A code in which a program of the present invention is described can be included as a firmware in a RAM, a ROM and a flash memory. Otherwise, the code can be stored in a tangible computer-readable storage medium such as a magnetic tape, a flexible disc, a hard disc, a compact disc, a photo-magnetic disc, a digital versatile disc (DVD). The present invention can be configured for use in a computer or an information processing apparatus which includes a memory, such as a central processing unit (CPU), a RAM and a ROM as well as a storage medium such as a hard disc.

The “step-by-step process” for performing the claimed functions herein is a specific algorithm, and may be shown as a mathematical formula, in the text of the specification as prose, and/or in a flow chart. The instructions of the software program create a special purpose machine for carrying out the particular algorithm. Thus, in any means-plus-function claim herein in which the disclosed structure is a computer, or microprocessor, programmed to carry out an algorithm, the disclosed structure is not the general purpose computer, but rather the special purpose computer programmed to perform the disclosed algorithm.

A general purpose computer, or microprocessor, may be programmed to carry out the algorithm/steps of the present invention creating a new machine. The general purpose computer becomes a special purpose computer once it is programmed to perform particular functions pursuant to instructions from program software of the present invention. The instructions of the software program that carry out the algorithm/steps electrically change the general purpose computer by creating electrical paths within the device. These electrical paths create a special purpose machine for carrying out the particular algorithm/steps.

Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

While the invention has been described with reference to preferred embodiments, it will be understood by those skilled in the art that various changes may be made and equivalent elements may be substituted for elements thereof without departing from the scope of the present invention. The scope of the present invention further includes any combination of the elements from the various embodiments set forth. In addition, modifications may be made to adapt a particular situation to the teachings of the present invention without departing from its essential scope. Therefore, it is intended that the invention not be limited to the particular embodiment disclosed as the best mode contemplated for carrying out this invention, but that the invention will include all embodiments falling within the scope of the appended claims.

What is claimed is:

1. A method for developing a trading system for use in trading in a financial market, the method comprising:
developing one or more cumulative trading strategies, each comprising one or more sub-trading strategies;
displaying graphical user interface (GUI) trading system parameters on a graphical user interface, the GUI trading system parameters associated with one or more trading system components;
selecting a sub-trading strategy using the graphical user interface; and
weighting each sub-trading strategy by performing at least one operation on a GUI trading system parameter, wherein each weight effectively values each sub-trading strategy within the cumulative trading strategy.

2. The method of claim 1 further comprising changing a GUI trading system parameter on the graphical user interface by adjusting a trading system graphic associated with the GUI trading system parameter, such that changing the GUI trading system parameter effectively changes an associated trading system component.

3. The method of claim 1 the trading system further comprising algorithm represented by a trading system graphic on the graphical user interface, the method further comprising a user changing an algorithm by performing an operation on an associated trading system graphic.

4. The method of claim 1 further comprising a logic engine of the trading system or independent of the trading system for recommending trading system components, the method further comprising evaluating the trading system components as to one or more of popularity among users, profitability over a predetermined time interval, and compatibility with current or expected future financial market conditions, and wherein responsive to a step of evaluating, the logic engine recommending use of the trading system component.

5. The method of claim 4 further comprising evaluating trading system components as to compatibility with current or expected future financial market conditions by testing with one or more of real-time, historical, and simulated data, and wherein performance of the trading system component is measured with at least one predetermined performance metric.

6. The method of claim 4 wherein one or more trading system components are evaluated by a step of data mining the performance of the trading system component as used in at least one trading system, the trading system operating in at least one financial market, wherein performance of the trading system component is measured by at least one predetermined performance metric.

7. The method of claim 1 further comprising portraying trade execution time to a user as a trading system graphic on the graphical user interface, wherein the trade execution time is an amount of time until a trade is executed or a time until at least one trade order is sent by an automated trading system, and wherein the method further comprising updating the trading system graphic in real time or in delayed time.

8. The method of claim 1 further comprising alerting a user that a trading system component is compatible or incompatible with current or future market conditions after determining compatibility of the trading system component by performing one or more of the operations of data mining and testing the trading system component as part of a user's trading strategy against real-time, historical, or simulated trading data resulting in a performance metric associated with the trading system component.

9. The method of claim 1 the user establishing a trading system component as either long or short by performing at least one operation on the trading system graphic.

10. The method of claim 9 the at least one operation comprising configuring a switch to indicate that the trading system component is either long or short during its operation in a trading system.

11. The method of claim 1 further comprising the user adjusting how capital is allocated by the trading system by performing an operation on a trading system graphic.

12. The method of claim 11 further comprising displaying the capital allocation to the user with a trading system graphic, the trading system graphic representing the capital allocation as set by the user or the actual capital allocation as used by the trading strategy.

13. The method of claim 11 further comprising updating at least one trading system graphic representative of cash, total positions, or a position type.

14. The method of claim 1 further comprising the user defining an amount of leverage to be applied by the trading system during its operation to each position for each position type by the user performing an operation on at least one trading system graphic of the graphical user interface.

15. The method of claim 1 further comprising defining the size of a position or the holding time of a position opened, managed, or exited by a trading system by performing an operation on at least one trading system graphic of the graphical user interface.

16. The method of claim 1 further comprising defining the times of operation for one or more trading systems, trading strategies, or trading system components by performing at least one operation on at least one trading system graphic of the graphical user interface.

17. The method of claim 1 further comprising displaying to the user, through at least one the trading system graphic, potential trades identified by a trading strategy using a scoring technique.

18. The method of claim 1 further comprising defining when a trading strategy should close, reduce in size, add-to, or hedge a position by performing at least one operation on a trading system graphic.

19. The method of claim 1 further comprising creating, modifying, or replacing a trading system or a trading system component responsive to at least one market factor.

20. The method of claim 1 further comprising testing revised trading systems, revised trading strategies, or revised trading system components by executing a simulated trade or a real trade, and determining a performance metric for the revised trading systems, revised trading strategies or the revised trading system components based on the simulated trade or the real trade, and using the revised trading systems, revised trading strategies, or revised trading system components having a performance metric greater than a predetermined performance metric value.

21. The method of claim 1 wherein a logic engine builds one or more of a new trading system, a new trading strategy, or a new trading system component by writing new code to create the one or more of the new trading system, the new trading strategy, or the new trading system component.

22. The method of claim 1 executed by a computer processor including artificial intelligence components.

23. A computer program product comprising a non-transitory computer readable storage media storing a computer program comprising computer executable instructions adapted to, when executed by a computer processor, perform the method according to claim 1.

24. A method for developing a trading system for use in trading in a financial market, the method comprising:
developing a plurality of sub-trading strategies each one of the plurality of sub-trading strategies including and controlled by trading system components;
displaying graphical user interface (GUI) trading system parameters on a graphical user interface, the GUI trading system parameters associated with one or more of the trading system components and selectable by a user;
using the graphical user interface, applying a weight to each one of the plurality of sub-trading strategies to create a plurality of weighted sub-trading strategies;
combining the plurality of weighted sub-trading strategy to create a cumulative trading strategy; and
executing a trade in a financial market using the cumulative trading strategy.

25. A method for developing a trading system for use in trading in a financial market, the method comprising:
a. developing a plurality of sub-trading strategies each one including trading system components and control algorithms;
b. displaying on a graphical user interface (GUI) the trading system components selectable by a user;
c. displaying on the GUI elements of the control algorithms, the elements selectable by the user;
d. using the graphical user interface, applying a weight to each one of the plurality of sub-trading strategies to create a plurality of weighted sub-trading strategies;
e. combining the plurality of weighted sub-trading strategies to create a cumulative trading strategy;
f. determining a performance value for the cumulative trading strategy by applying the cumulative trading strategy to historical financial market information;
g. changing the trading system components and the elements;
h. repeating steps d, e, and f to determine a performance value for each one of a plurality of cumulative trading strategies;
i. selecting a cumulative trading strategy responsive to the performance values for each one of the plurality of cumulative trading strategies; and
j. executing a trade in a financial market using the cumulative trading strategy selected at a step i.
